(19) United States
(12) Patent Application Publication
(10) Pub. No.: US 2026/0302993 A1
(43) Pub. Date: Oct. 1, 2026

(54) INDEXED COMPENSATION FOR A MOTOR DRIVE SYSTEM

(71) Applicant: POWER INTEGRATIONS, INC., SAN JOSE, CA (US)

(72) Inventors: John Emmanuel Atienza TAN, Antipolo City (PH); John Henry Rementilla PUENTE, Cambridge (GB); Jhaebhee Mark Quiroz CALDERON, Pasig (PH); Juan Paolo Bernabe QUISMUNDO, Pasig City (PH)

(73) Assignee: POWER INTEGRATIONS, INC., SAN JOSE, CA (US)

(21) Appl. No.: 19/477,663

(22) PCT Filed: Oct. 31, 2023
(86) PCT No.: PCT/US2023/036410

§ 371 Date: Oct. 22, 2025

Related U.S. Application Data
(60) Provisional application No. 63/465,181, filed on May 9, 2023.

(51) Int. Cl. H02P 27/08

(52) U.S. Cl. CPC H02P 27/08

(57) ABSTRACT

A system controller for a motor drive system comprising a state controller coupled to receive a command from a user input and to output a target duty ratio, an indexed compensator coupled to receive the target duty ratio and coupled to perform operations comprising receiving a sensed input voltage signal, determining a total number of segments and a current index value of the sensed input voltage signal, determining an access index value based on the current index value, selecting a stored compensation factor in response to the access index value, and outputting a compensated duty ratio in response to a product of the stored compensation factor and the target duty ratio. The system controller comprises a control signal generator coupled to generate control signals for a plurality of devices that operate to drive the motor drive system in response to the compensated duty ratio.

### CROSS-REFERENCE TO RELATED APPLICATIONS

This application is a national stage application under 35 U.S.C. 371 of International Application No. PCT/US2023/036410, filed Oct. 31, 2023, which claims the benefit of U.S. Provisional Application No. 63/465,181, filed May 9, 2023. U.S. Provisional Application No. 63/465,181 and International Application No. PCT/US2023/036410 are incorporated by reference in their entirety.

### BACKGROUND OF THE INVENTION

### Field of the Invention

The present disclosure relates generally to motor drivers, and more specifically related to brushless dc motor drivers.

### Discussion of the Related Art

Household and industrial appliances such as ventilation fans, cooling systems, refrigerators, dishwasher, washer/dryer machines, and many other white products/goods typically utilize electric motors that transfer energy from an electrical source to a mechanical load. Electrical energy for driving the electric motors is provided through a drive system, which draws electrical energy from an electrical source (e.g., from an AC low frequency source). The electrical energy is processed through a power converter and converted to a desired form of electrical energy that is supplied to the motor to achieve the desired mechanical output. The desired mechanical output of the motor may be for example the speed of the motor, the torque, or the position of a motor shaft.

Motors and their related circuitries, such as motor drivers, represent a large portion of network loads. The functionality, efficiency, size, and price of motor drivers are challenging and competitive factors that suppliers of these products consider. The function of a power converter in a motor drive includes providing the input electrical signals to the motor, in a form of varying voltage and current for a desired mechanical output in a form of speed, torque and position. The power converter in one example may be an inverter transferring a dc input to an ac output of desired voltage, current, frequency, and phase. A controller of the power converter regulates the energy flow in response to signals that are received from a sensor block. The small signals sensed from the motor (e.g. position sensors) or power converter are sent to the controller in a closed loop system by comparing the actual values to the desired values. The controller adjusts the output in comparison of the actual values to the desired values to maintain the target output.

Brushless dc (BLDC) motors, which are known for their higher reliability and efficiency, are becoming a popular choice in the market, replacing brushed dc motors. They are widely used in household appliances, such as refrigerators, air conditioners, vacuum cleaners, washers/dryers, and other white goods, and power tools such as electric drills, or other electric tools. A BLDC motor utilizes a power converter, which typically includes an inverter stage as a combination of half-bridge switcher modules. An integrated half-bridge switcher module includes two power switches and their logic and control blocks which provides a compact structure having a smaller size and higher efficiency.

### SUMMARY OF THE DISCLOSURE

A BLDC motor utilizes a power converter, which typically includes an inverter stage of one or more half-bridge modules. The half-bridge modules generally include two power switches, a high-side power switch and a low-side power switch coupled in a half-bridge configuration, and their respective switch controllers to drive the power switches ON or OFF. A motor drive system for a BLDC motor also generally includes a system controller which receives sense signals regarding properties of the motor and sends control signals to the half-bridge modules to control the turn ON and turn OFF the power switches and therefore control the desired motion of the rotor shaft of the BLDC motor.

A three-phase motor has three terminals, typically referred to as U, V, and W, with three windings. The windings and subsequent phases are generally referred to by the terminal they correspond with. A motor drive system for the three-phase motor utilizes a system controller and three half-bridge modules to control the magnitude and direction of the three phase currents of the motor: I_{PHASEU}, I_{PHASEV}, I_{PHASEW}. The system controller may employ several different control schemes, such as trapezoidal commutation, sinusoidal commutation, or field-oriented control to control the three phase currents of the motor: I_{PHASEU}, I_{PHASEV}, I_{PHASEW}. For trapezoidal commutation, current is controlled through motor terminals one pair at a time, with the third motor terminal undriven. Sinusoidal commutation attempts to drive the three motor windings with phase currents, I_{PHASEU}, I_{PHASEV}, I_{PHASEW}, to be sinusoidal in shape. Field-oriented control is a control scheme which takes advantage of the representation of the phase currents I_{PHASEU}, I_{PHASEV}, I_{PHASEW} as vectors, often called current space vectors.

For each of these control methods, the system controller determines the duty ratio for the motor drive system to control the motor winding phase currents to their desired values. In one example, the duty ratio for the motor drive system is the percentage of voltage to be used from the input voltage of the motor drive system. Said differently, the duty ratio for the motor drive system is the percentage of the input voltage to be delivered to the motor. The duty ratio of the motor drive system may then be utilized to determine the duty ratio of the high-side power switch and the low-side power switch for each half-bridge module. The duty ratio for the high-side power switch and the low-side power switch of each half-bridge module may refer to the ratio of the on-time of the respective power switch to the switching period of the respective power switch. Microcontrollers, such as the Cortex-MO microcontroller, are often used for the system controllers for a motor drive system. These microcontrollers generally have about 32-300 kB flash memory, about 8-16 kB of RAM, with a processing speed of about 48 MHz.

Motor drive systems may be designed to meet power factor correction (PFC) and/or total harmonic distortion (THD) requirements set by either regulatory agencies or customer specifications. Power factor refers to the ratio of the average power over a cycle and the product of the root mean square (rms) voltage and the rms current. The power factor has a value between zero and one with unity power factor as the ideal case. In general, a PFC circuit shapes the input current waveform as closely to the input voltage waveform in an attempt to achieve unity power factor. THD is a measurement of the harmonic distortion present in a signal and is generally the ratio of the equivalent rms value of all harmonic frequencies over the rms value of the fundamental frequency of the signal. A THD correction circuit shapes the input current waveform as closely to the input voltage to reduce the THD.

Motor drive systems may utilize passive PFC circuits as they are generally inexpensive compared to active PFC circuits. One common passive PFC circuit is a valley-fill PFC. The output of a valley-fill PFC circuit is the input voltage V_{IN} to the motor drive system. The valley-fill PFC circuit provides an input voltage V_{IN} with a distinctive non-sinusoidal shape and ripple to the motor drive system. The ripple present in the input voltage V_{IN} may result in torque ripple for the motor. With the non-sinusoidal shape of passive PFC circuits, there is usually a trade-off between achieving unity power factor and reducing THD. There is also usually a trade-off between the cost of the system and the amount of THD present.

In one embodiment of the present disclosure, the system controller compensates for the ripple in the input voltage V_{IN} by compensating the motor drive duty ratio. In another embodiment, the system controller compensates for THD by compensating the motor drive duty ratio. THD compensation may be performed by reshaping the input current I_{IN} of the motor drive system. The system controller includes an indexed compensator to compensate the duty ratio of the motor drive system by a compensation factor in response to the input voltage V_{IN} of the motor drive system. The compensation of the duty ratio may reduce the effect of the input voltage V_{IN} ripple on the torque of the motor. The compensation of the duty ratio may also reduce the THD for the motor drive system. By providing compensation factors in response to the input voltage V_{IN}, the system controller may provide compensation for the motor drive system within the processing speed limits of the system controller

The input voltage V_{IN} is organized into segments and each segment is given an index value. In particular, the period of the input voltage V_{IN} is segmented and given an index value. The total number of indexed segments within a period of the input voltage V_{IN} may be in response to the frequency of the input voltage V_{IN} and the frequency of the control loop utilized by the system controller. The indexed compensator also includes a memory that stores a compensation factor which corresponds with each segment of the input voltage V_{IN}. The compensation factor is stored at the index value corresponding with each segment. The index value may be used to access the stored compensation factors. The compensation factor is the ratio of the target value of the element which the system controller is compensating for and the actual value of the element.

The indexed compensator determines the current index value in response to the input voltage V_{IN}. In particular, the indexed compensator determines the current index value for the instantaneous moment of time within a period of the input voltage V_{IN}. An access index value is determined in response to the current index value. The indexed compensator then selects the compensation factor stored in the memory at the accessed index value. The indexed compensator outputs a compensated duty ratio in response to the selected compensation factor and a target duty ratio for the motor drive system. The system controller may utilize an indexed compensator to compensate the target duty ratio of the motor drive system for compensation of the input voltage V_{IN}, compensation for THD, or to compensate for both input voltage V_{IN} and THD.

### BRIEF DESCRIPTION OF DRAWINGS

Non-limiting and non-exhaustive embodiments of the present invention are described with reference to the following figures, wherein like reference numerals refer to like parts throughout the various views unless otherwise specified. Corresponding reference characters indicate corresponding components throughout the several views of the figures.

FIG. 1 illustrates an example motor drive system with indexed compensation, in accordance with teachings of the present disclosure.

FIG. 2 illustrates example waveforms of the sensed input voltage signal VSEN, average input voltage signal VAVG, sensed input current signal ISEN shown in FIG. 1, in accordance with teachings of the present disclosure.

FIG. 3 illustrates an example system controller with indexed compensation of FIG. 1, in accordance with teachings of the present disclosure.

FIG. 4A illustrates an example indexed compensator of FIG. 3, in accordance with teachings of the present disclosure.

FIG. 4B illustrates another example indexed compensator of FIG. 3, in accordance with teachings of the present disclosure.

FIG. 4C illustrates a further example indexed compensator of FIG. 3, in accordance with teachings of the present disclosure.

FIG. 4D illustrates an additional example indexed compensator of FIG. 3, in accordance with teachings of the present disclosure.

FIG. 5 is a flow chart illustrating one method of selecting a compensation factor, in accordance with teachings of the present disclosure.

FIG. 6A illustrates an example indexed compensator of FIG. 3, in accordance with teachings of the present disclosure.

FIG. 6B is a flow chart illustrating one method of selecting a compensation factor for the indexed compensator of FIG. 6A, in accordance with teachings of the present disclosure.

FIG. 7A illustrates an example synchronizer of FIGS. 4A, 4B, 4C, 4D, and 6A, in accordance with teachings of the present disclosure.

FIG. 7B is a flow chart illustrating one method of determining a total number of segments and a current index value for the synchronizer of FIG. 7A, in accordance with teachings of the present disclosure.

FIG. 8A illustrates an example system controller with indexed compensation of FIG. 1, in accordance with teachings of the present disclosure.

FIG. 8B illustrates an example indexed compensator of FIG. 8A, in accordance with teachings of the present disclosure.

FIG. 9 is a flow chart illustrating one method of indexed compensation, in accordance with teachings of the present disclosure.

### DETAILED DESCRIPTION

A system controller may compensate for the undesirable properties of the inputs of the motor drive system. The system controller may compensate for the ripple in the input voltage V_{IN} to reduce torque ripple. System controllers may also compensate for a non-sinusoidal input current I_{IN} to reduce total harmonic distortion (THD). The system controller utilizes an indexed compensator to compensate for one or more of these properties.

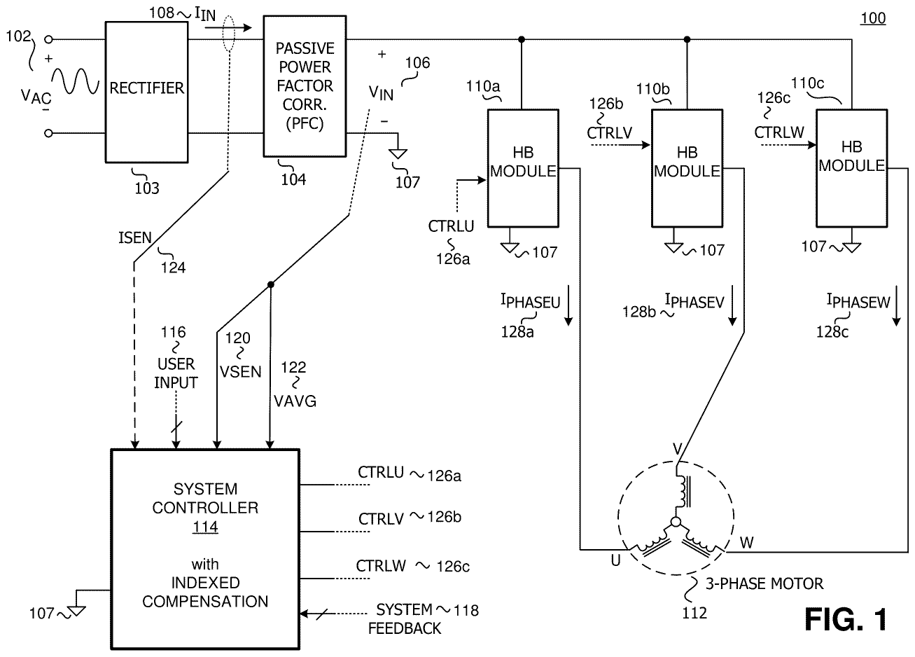

FIG. 1 illustrates a motor drive system 100 including three half-bridge modules 110a, 110b, and 110c which are controlled by a system controller 114 to drive a 3-phase motor 112. The motor drive system 100 receives an ac input voltage V_{AC} 102. The motor drive system 100 includes a rectifier 103 which converts an alternating current (ac) source to direct current (dc). Rectifier 103 provides input current I_{IN} 108 to a power factor correction (PFC) circuit 104. In one example, the PFC circuit 104 may be a passive PFC circuit such as a valley-fill circuit. The PFC circuit 104 provides input voltage V_{IN} 106 to the half-bridge modules 110a, 110b, and 110c.

Each half-bridge inverter modules 110a, 110b, and 110c and the system controller 114 are referenced to return 107. Each half bridge module 110a, 110b, and 110c is coupled to the three phase terminals U, V, and W of the motor 112. The current for each phase/leg of the motor 112 is denoted as phase currents I_{PHASEU} 128a, I_{PHASEV} 128b, and I_{PHASEW} 128c. Although not illustrated, each half-bridge module 110a, 110b, and 110c, includes a high-side power switch and a low-side power switch coupled together as a power converter or an inverter in a half-bridge configuration. In one example, the high-side power switch and the low-side power switch may be n-type metal-oxide-semiconductor field-effect transistor. However, other transistors may be used, such as an insulated-gate bipolar transistor (IGBT), bipolar transistors, injection enhancement gate transistors (IEGTs) and gate turn-off thyristors (GTOs). In addition, half-bridge module 110a, 110b, and 110c could be used with power switches which are based on silicon (Si), gallium nitride (GaN) semiconductors, or silicon carbide (SiC) semiconductors. The half-bridge mid-point terminals between each high-side switch and low-side switch of their respective half-bridge modules 110a, 110b, and 110c, are coupled to the three phase terminals U, V, W of the multi-phase motor 112. In one example, the motor 112 is a brushless three-phase DC motor. Although a three-phase motor is shown, it should be appreciated that embodiments of the present disclosure may be used with motors with less or more phases.

The turn ON and OFF of each high-switch power switch is controlled by its respective high-side switch controller while the turn ON and turn OFF of each low-side power switch is controlled by its respective low-side switch controller. The switching properties of these switches are controlled by their respective switch controllers to regulate the energy flow to the motor 112. In other words, the switches adjust the outputs to the motor 112 to maintain the target operation of the motor 112. In operation, the half-bridge modules 110a, 110b, and 110c provide the input electrical signals (such as voltage, current, frequency, and phase for the desired mechanical output load motion) to the motor 112 from the electrical energy supplied by the input voltage V_{IN} 106. In one example, the half-bridge modules 110a, 110b, and 110c control the phase currents I_{PHASEU} 128a, I_{PHASEV} 128b, and I_{PHASEW} 128c to control the motor 112 to the target operation.

System controller 114 is coupled to receive one or more command signals from a user input 116 to control the operation of the motor 112. For example, system controller 114 may receive an “ON” command to turn on and begin operation of motor 112, or conversely, may receive an “OFF” command to stop operation of motor 112. Further command signals from user input 116 may include the desired mechanical outputs of the motor 112, such as the speed or torque. Further, the system controller 114 is coupled to receive system feedback 118 regarding the motor drive system 100. The system feedback 118 is representative of one or more parameters of the motor drive system 100. For example, system feedback 118 may include current sense signals representative of the phase currents I_{PHASEU} 128a, I_{PHASEV} 128b, and I_{PHASEW} 128c of the motor 112. In one example, current sense signals representative of the phase currents may be received from the corresponding half-bridge module 110a, 110b, and 110c. In another example, current sense signals representative of the phase currents may be received from one or more Hall Effect current sensors. The system feedback 118 may also include a position signal representative of the position of the rotor with respect to the stator of motor 112.

In response to the command signals from the user input 116 and the system feedback 118, the system controller 114 outputs control signals CTRLU 126a, CTRLV 126b, and CTRLW 126c to half-bridge modules 110a, 110b, 110c, respectively, to control the turn ON and turn OFF of their respective high-side power switches and low-side power switches. In other words, control signals CTRLU 126a, CTRLV 126b, and CTRLW 126c are representative of a command to turn ON or turn OFF the high-side and low-side power switch of the applicable half-bridge module. Control signals CTRLU 126a, CTRLV 126b, and CTRLW 126c may also be representative of switching properties of the respective power switches. Switching properties may include the on-time of the power switch, off-time, the duty ratio (typically the ratio of the on time of the switch to the total switching period of the switch), the switching frequency, or the number of pulses per unit time of the power switch.

In one example, control signals CTRLU 126a, CTRLV 126b, and CTRLW 126c are rectangular pulse width waveforms with varying lengths of high and low durations. In one example, a high value for control signals CTRLU 126a, CTRLV 126b, and CTRLW 126c correspond with turning ON the respective high-side switch and turning OFF the respective low-side switch. A low value for control signals CTRLU 126a, CTRLV 126b, and CTRLW 126c correspond with turning ON the respective low-side switch and turning OFF the respective high-side switch. The ratio of the high duration for the control signal (CTRLU 126a, CTRLV 126b, or CTRLW 126c) to the total period of the respective control signal (CTRLU 126a, CTRLV 126b, or CTRLW 126c) may be referred to as the duty ratio of the power switches for the respective half-bridge module 110a, 110b, and 110c.

As will be further discussed, system controller 114 includes an indexed compensator. The system controller 114 is coupled to receive the sensed input voltage signal VSEN 120. The system controller 114 is also coupled to receive the average input voltage signal VAVG 122. The sensed input voltage signal VSEN 120 is representative of the sensed instantaneous value of the input voltage V_{IN} 106. The system controller 114 may optionally receive the sensed input current signal ISEN 124, as demonstrated by the dashed line. The sensed input current signal ISEN 124 is representative of the sensed instantaneous value of the input current I_{IN} 108.

In one example, a resistor divider network followed by a capacitance can be utilized to provide the sensed input voltage signal VSEN 120 from the input voltage V_{IN} 106. In other words, a resistor divider with low pass filter. Similarly, a resistor divider network followed by a capacitance can also be utilized to provide the average input voltage signal VAVG 122 from the input voltage V_{IN} 106. In other words, a resistor divider with low pass filter. However, the capacitance used to provide the average input voltage signal VAVG 122 is larger than the capacitance used for the sensed input voltage signal VSEN 120. In another example, the average input voltage signal VAVG 122 may be calculated by the system controller 114.

The system controller 114 determines the target duty ratio of the motor drive system 100 in response to the system feedback 118 and one or more commands from the user input 116. The duty ratio for the motor drive system may refer to the percentage of the input voltage V_{IN} 106 used by the motor drive system 100. The target duty ratio of the motor drive system 100 may then be utilized to generate the control signals CTRLU 126a, CTRLV 126b, CTRLW 126c.

The system controller 114 includes an indexed compensator which may compensate for undesirable properties of one or more inputs of the motor drive system 100. For example, the system controller 114 may compensate for the input voltage V_{IN} 106, the input current I_{IN} 108, or both. The input voltage V_{IN} 106 is organized into segments with each segment given an index value. In particular, the period of the input voltage V_{IN} 106 is segmented and given an index value. The total number of indexed segments within a period of the input voltage V_{IN} 106 may be in response to the frequency of the input voltage V_{IN} and the frequency of the control loop utilized by the system controller 114. The system controller 114 utilizes the sensed input voltage signal VSEN 120 and the average input voltage signal VAVG 122 to determine the current index value of the input voltage V_{IN} 106.

The system controller 114 includes a memory that stores a compensation factor which corresponds with each segment of the input voltage V_{IN} 106. The memory may utilize the index value as a reference or pointer to store and retrieve the compensation factor. The compensation factor is the ratio of the target value of the element which the system controller 114 is compensating for and the actual value of the element.

In one example, the system controller 114 may compensate for ripple present in the input voltage V_{IN} 106. The target value for input voltage compensation is the average input voltage signal VAVG 122. As such, the compensation factor (CF) is the ratio of the average input voltage signal VAVG 122 to the sensed input voltage signal VSEN 120, or mathematically:

$$CF = \frac{VAVG}{VSEN} \qquad ( 1 )$$

In another example, the system controller 114 may compensate for the shape of the input current I_{IN} 108. For applications such as reduction of total harmonic distortion (THD), the target shape for the input current I_{IN} 108 is substantially sinusoidal. The compensation factor may be the ratio to a reference sinusoidal waveform IREFSINE to the sensed input current signal ISEN 124, or mathematically:

$$CF = \frac{IREFSINE}{ISEN} .$$

However, the input voltage V_{IN} 106 is generally sinusoidal in shape and may be utilized as the target shape for the input current I_{IN} 108. As such in another example, the compensation factor (CF) is the ratio of the sensed input voltage signal VSEN 120 to the sensed input current signal ISEN 124. However, it should be appreciated that the sensed input voltage signal VSEN 120 and the sensed input current signal ISEN 124 may not be in the same scale and should be normalized. As such, in another example the compensation factor (CF) is the ratio of the normalized sensed input voltage signal VSEN 120 to the normalized sensed input current signal ISEN 124, or mathematically:

$$CF = \frac{VSEN\_norm}{ISEN\_norm} \qquad ( 2 )$$

The system controller 114 determines the current index value in response to the input voltage V_{IN}. In particular, the system controller determines the current index value in response to the sensed input voltage signal VSEN 120 and the average input voltage signal VAVG 122. The system controller determines an access index value. The access index value is representative of the reference or pointer of the memory where the compensation factor is retrieved. The access index value is determined in response to the current index value. Further, the access index value is determined in response to the current index value and an offset factor. The current index value is represented with the variable k while the offset factor is represented with the variable 1. The access index value is the substantially the sum of the current index value, k, and the offset factor, 1, or mathematically:

$$Access Index Value ( AIV ) = k + l \qquad ( 3 )$$

The offset factor is representative of how far ahead (e.g. leading) or how far behind (e.g. trailing) of the current index value which the system controller 114 will compensate the target duty ratio of the motor drive system 100. A positive offset factor is representative of leading compensation while a negative offset factor is representative of trailing compensation. In an embodiment, the system controller 114 utilizes leading compensation to apply the compensation factor to the target duty ratio of the motor drive system 100.

The system controller 114 selects the compensation factor stored in the memory at the access index value. The system controller 114 determines a compensated duty ratio in response to the selected compensation factor and the target duty ratio for the motor drive system 100. The compensated duty ratio is in response to the product of the selected compensation factor and the target duty ratio of the motor drive system 100. In other words, the compensated duty ratio is substantially the product of the compensation factor stored at the access index value and the target duty ratio. In another example, the compensated duty ratio is substantially the product of the selected compensation factor, the target duty ratio, and a scaling factor(s). The scaling factor(s) is representative of how strongly the compensation factor affects the target duty ratio. If the scaling factor is less than one, the effect of the compensation factor is attenuated. If the scaling factor(s) is greater than one, the effect of the compensation factor is amplified.

It should be appreciated that the system controller 114 may compensate for both the input voltage V_{IN} 106 and the input current I_{IN} 108. As such, the system controller 114 may determine a compensated duty ratio which is a product of multiple compensation factors and the target duty ratio of the motor drive system 100.

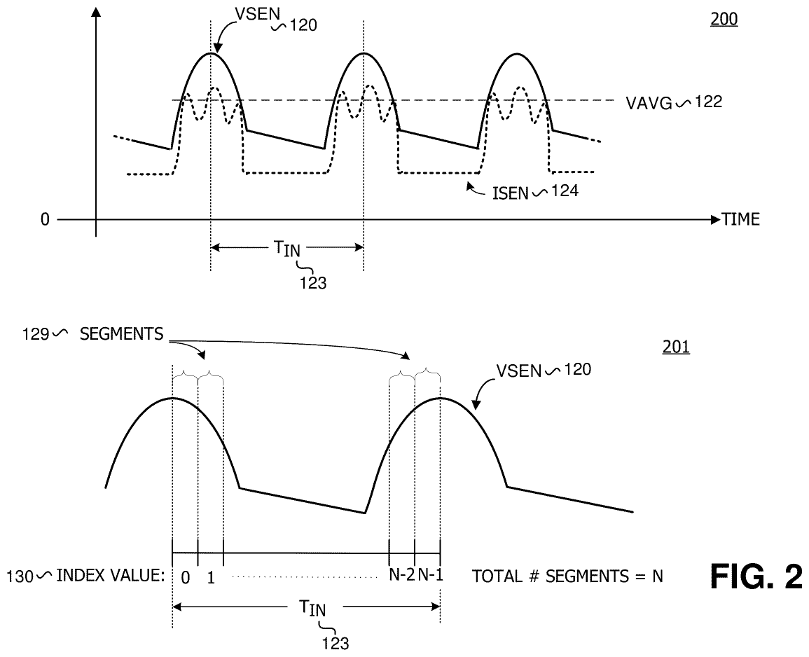

FIG. 2 illustrates diagram 200 of example waveforms of the sensed input voltage signal VSEN 120, average input voltage signal VAVG 122, and the sensed input current signal ISEN 124 and diagram 201 illustrates the corresponding segments and index values. In diagram 200, the sensed input voltage signal VSEN 120 is represented by a solid line. The waveform shape of the sensed input voltage signal VSEN 120 is a typical output of a valley-fill passive power factor correction (PFC) circuit. The sensed input voltage signal VSEN 120 is a rectified and shifted ac input voltage V_{AC} 102. A ripple is observed in the sensed input voltage signal VSEN 120 which may cause torque ripple of the motor 112. The average input voltage signal VAVG 122 is represented by a dashed line. The average input voltage signal VAVG 122 is the average value of the input sensed input voltage signal VSEN 120. The sensed input current signal ISEN 124 is represented by a dotted line. The shape of the sensed input current signal ISEN 124 is a function of the valley-fill PFC circuit, inverter driving signals and the motor characteristics within the motor drive system 100.

The sensed input voltage signal VSEN 120 is a periodic signal. The period T_{IN} 123 of the sensed input voltage signal VSEN 120 is shown as measured from the peak to peak of the sensed input voltage signal VSEN 120. It should be appreciated that the period T_{IN} 123 of the sensed input voltage signal VSEN 120 is a representation of the period of the input voltage V_{IN} 106. The period T_{IN} 123 may be measured in various ways. For example, the period T_{IN} 123 may be measured from the beginning of valley to the next beginning of valley of the sensed input voltage signal VSEN 120 or the end of valley to the next end of valley of the sensed input voltage signal VSEN 120.

Diagram 201 illustrates the segments 129 and corresponding index value of the sensed input voltage signal VSEN 120. The segments 129 shown also correspond with the input voltage V_{IN} 106. As shown, the period T_{IN} 123 of the sensed input voltage signal VSEN 120 may be organized into segments 129. For the period T_{IN} 123, there is substantially a total of N number of segments 129. The index values 130 correspond to the segments 129 and begins at 0 and continues to N-1. In one embodiment, the first segment is delineated at the peak of the sensed input voltage signal VSEN 120 and is given an index value of zero. The last segment is delineated at the subsequent peak of the sensed input voltage signal VSEN 120 and is given the index value of N-1, with N being the total number of segments. It should be appreciated that the total N number of segments is determined by the ratio of the frequency of the control loop of the system controller 114 to the frequency of the sensed input voltage signal VSEN 120. Said differently, the total N number of segments is determined by the ratio of the period T_{IN} 123 of the input voltage VSEN 120

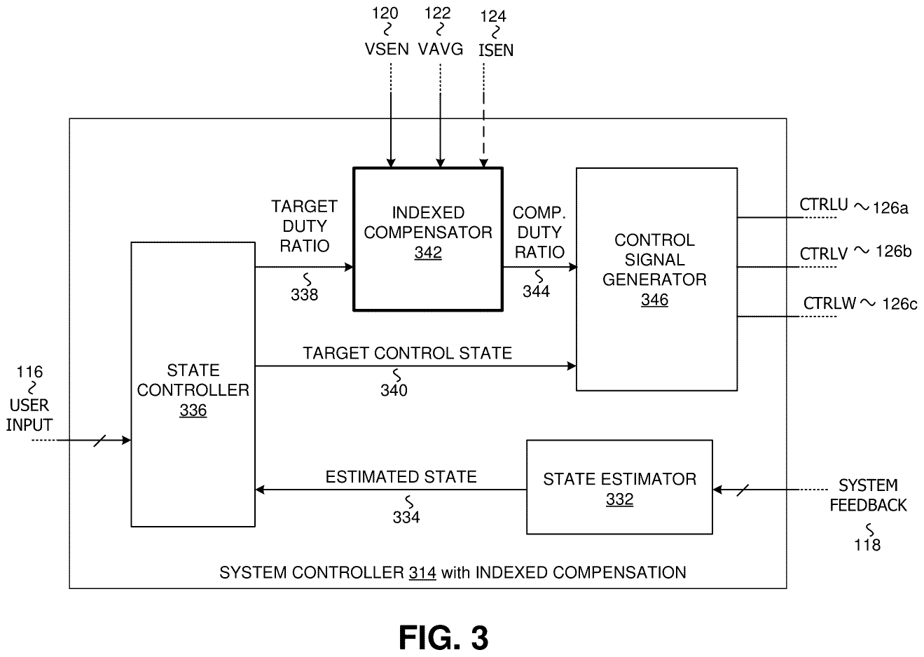

FIG. 3 illustrates a system controller 314 which includes an indexed compensator 342. The system controller 314 is one example of system controller 114, and similarly named and numbered elements couple and function as described above. The system controller 314 includes a state estimator 332, a state controller 336, an indexed compensator 342, and a control signal generator 346.

State estimator 332 is coupled to receive system feedback 118. The system feedback 118 is representative of one or more parameters of the motor drive system 100. For example, system feedback 118 may include current sense signals representative of the phase currents I_{PHASEU} 128a, I_{PHASEV} 128b, and I_{PHASEW} 128c of the motor 112. The system feedback 118 may also include a position signal representative of the position of the rotor with respect to the stator of motor 112. The state estimator 332 determines and outputs the estimated state 334 of the motor drive system 100 in response to the system feedback 118. The estimated state 334 is representative of the current state of the motor 112 for whichever control scheme the motor drive system 100 is utilizing. For the example of trapezoidal control, the estimated state 334 may be representative of the current rotor position of the motor 112. The current rotor position may be sensed with the use of Hall sensors. For the example of field-oriented control, the estimated state may be the determined rotor angle and phase current vector representative of a direct-component and a quadrature-component.

State controller 336 is coupled to receive the user input 116 and the estimated state 334. The state controller 336 receives one or more command signals from a user input 116 to control the operation of the motor 112. For example, system controller 114 may receive an “ON” command to turn on and begin operation of motor 112, or conversely, may receive an “OFF” command to stop operation of motor 112. Further command signals from user input 116 may include the desired mechanical outputs of the motor 112, such as the speed or torque. In response to the one or more commands from the user input 116 and the determined current estimated state 334 of the motor 112, the state controller 336 determines and outputs a target duty ratio 338 and a target control state 340. The state controller 336 determines the desired control state to operate the motor 112. The target duty ratio 338 is representative of the desired percentage used of the input voltage V_{IN} 106 used by the motor drive system 100. The target control state 340 is representative of the desired control state of the motor 112 for whichever control scheme utilized by the system controller 314. For the example of trapezoidal control, the target control state 340 may be representative of the desired inverter switching pattern to drive the motor 112. For the example of field-oriented control, the estimated state may be the desired stator angle representative as the control signals for the direct-component and quadrature-component.

Indexed compensator 342 is coupled to receive the sensed input voltage signal VSEN 120 and the target duty ratio 338. Indexed compensator 342 is also coupled to receive the average input voltage signal VAVG 122, The indexed compensator 342 may also optionally receive the sensed input current signal ISEN 124, as denoted by the dashed line. The indexed compensator 342 receives the target duty ratio 338 and outputs a compensated duty ratio 344. In one example, the average input voltage signal VAVG 122 is sensed from input voltage V_{IN} 106. In another example, the average input voltage signal is calculated from the sensed input voltage signal VSEN 120.

The system controller 314 utilizes the indexed compensator 342 to compensate for properties of one or more inputs of the motor drive system 100, such as the input voltage V_{IN} 106, the input current I_{IN} 108, or both. As mentioned above, the input voltage V_{IN} 106 is organized into segments 129 with each segment given an index value 130. In particular, the period T_{IN} 123 of the input voltage V_{IN} 106 is segmented and given an index value 130. The total N number of indexed segments within a period T_{IN} 123 of the input voltage V_{IN} 106 may be in response to the frequency of the input voltage V_{IN} 106 and the frequency of the control loop utilized by the system controller 314. Indexed compensator 342 utilizes the sensed input voltage signal VSEN 120 and the average input voltage signal VAVG 122 to determine the current index value of the motor drive system 100. The indexed compensator 342 also utilizes the sensed input voltage signal VSEN 120 and the average input voltage signal VAVG 122 to determine the total N number of segments in a period T_{IN} 123 of the sensed input voltage signal VSEN 120.

The indexed compensator 342 may also optionally include a compensation factor calculator to determine the compensation factor for every index value of the sensed input voltage signal VSEN 120. As such, the indexed compensator 342 may continuously update the compensation factor. The compensation factor is the ratio of the target value of the element which the system controller 114 is compensating for and the actual value of the element. Example compensation factors are discussed above with respect to equation (1) and equation (2).

The indexed compensator 342 includes a memory that stores the compensation factor that corresponds with each segment 129 of the input voltage V_{IN} 106. The memory may utilize the index value as a reference or pointer to retrieve the compensation factor. The indexed compensator 342 determines an access index value. The access index value is representative of the reference or pointer of the memory where the compensation factor is retrieved. The access index value is determined in response to the current index value and an offset factor. The current index value is represented with the variable k while the offset factor is represented with the variable 1. The access index value is substantially the sum of the current index value (k) and the offset factor (1). The indexed compensator 342 utilizes leading compensation to apply the compensation factor to the target duty ratio of the motor drive system 100.

The indexed compensator 342 selects the compensation factor stored in the memory at the access index value. As mentioned above, the access index value is partially determined by the current index value. The current index value is determined in response to the sensed input voltage signal VSEN 120 and the average input voltage signal VAVG 122. As such, the indexed compensator 342 selects the compensation factor in response to the sensed input voltage signal VSEN 120 and the average input voltage signal VAVG 122. The indexed compensator 342 determines and outputs the compensated duty ratio 344 in response to the selected compensation factor and the target duty ratio 338. In one example, the compensated duty ratio 344 is substantially the product of the selected compensation factor and the target duty ratio 338. In other words, the compensated duty ratio 344 is substantially the product of the compensation factor stored at the access index value and the target duty ratio 338. In another example, the compensated duty ratio 344 is substantially the product of the selected compensation factor, the target duty ratio 338, and a scaling factor(s). The scaling factor(s) is representative of how strongly the compensation factor affects the target duty ratio 338. If the scaling factor(s) is less than one, the effect of the compensation factor is attenuated. If the scaling factor(s) is greater than one, the effect of the compensation factor is amplified.

It should be appreciated that the system controller 314 may compensate for both the input voltage V_{IN} 106 and the input current I_{IN} 108. As such, in one example the indexed compensator 342 may output a compensated duty ratio 344 which is the product of multiple compensation factors and the target duty ratio 338. In another example, the indexed compensator may output a compensated duty ratio 344 which is the product of multiple compensation factors, multiple scaling factors, and the target duty ratio 338.

Control signal generator 346 is coupled to receive the target control state 340 and the compensated duty ratio 344. Control signal generator 346 outputs control signal CTRLU 126a, CTRLV 126b, and CTRLW 126c in response to the target control state 340 and the compensated duty ratio 344. In operation, the control signal generator 346 converts the compensated duty ratio 344 and the target control state 340 to the control signals CTRLU 126a, CTRLV 126b, and CTRLW 126c used to control the respective half-bridge modules. The conversion by the control signal generator 346 is determined by the control scheme implemented by the system controller 314. In one example of trapezoidal control, the control signal generator 346 includes a switching pattern selector and generator. In the example of field-oriented control, the control signal generator 346 includes the reference frame translator and space vector modulator.

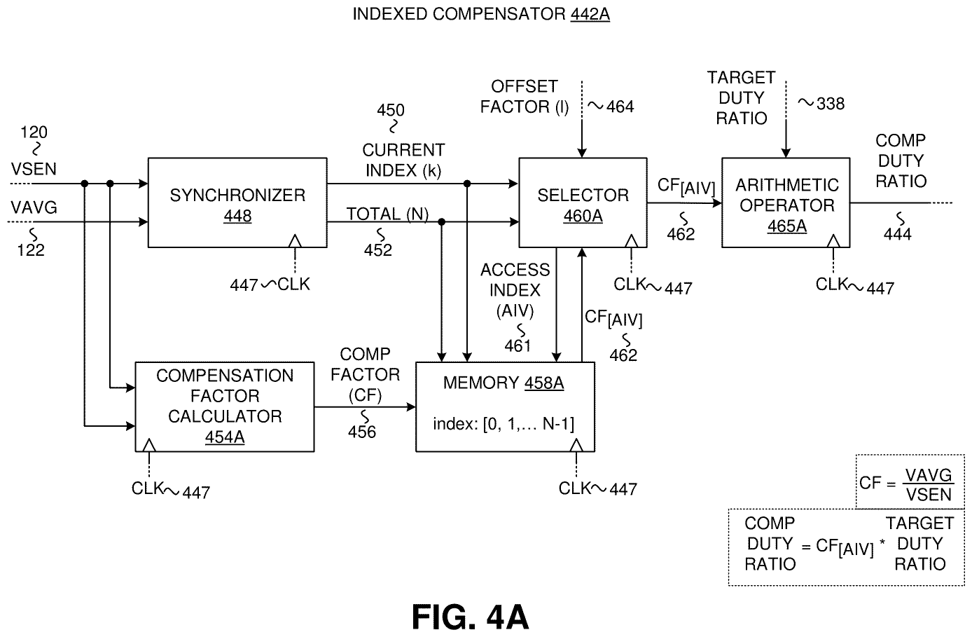

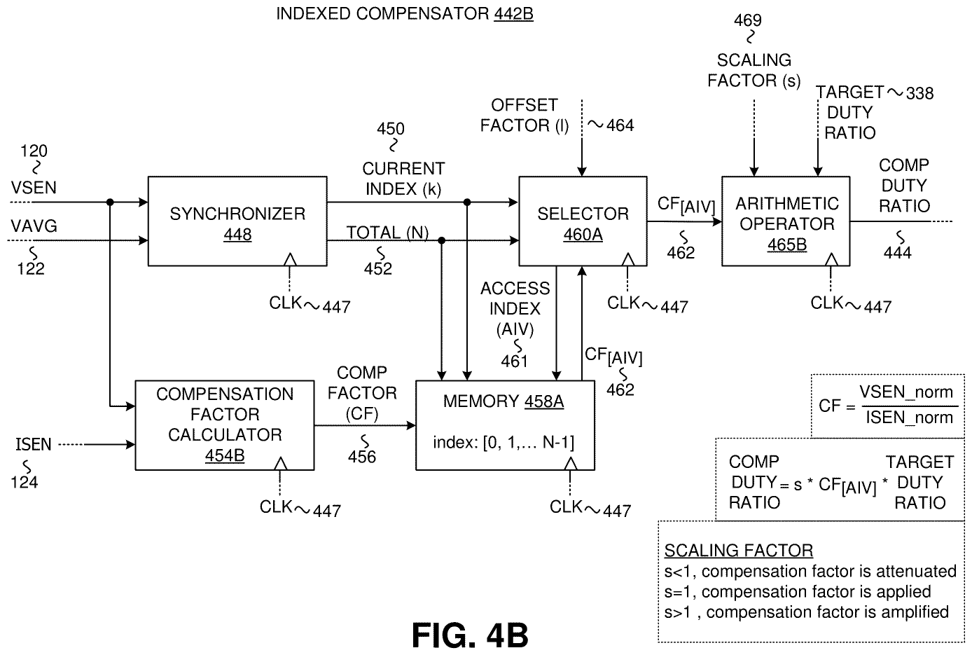

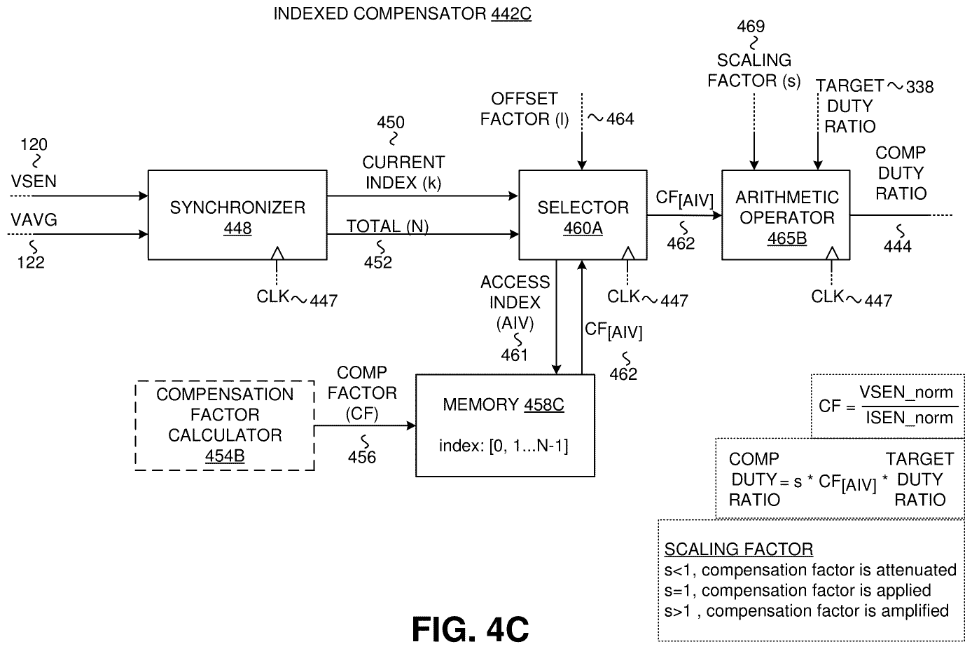

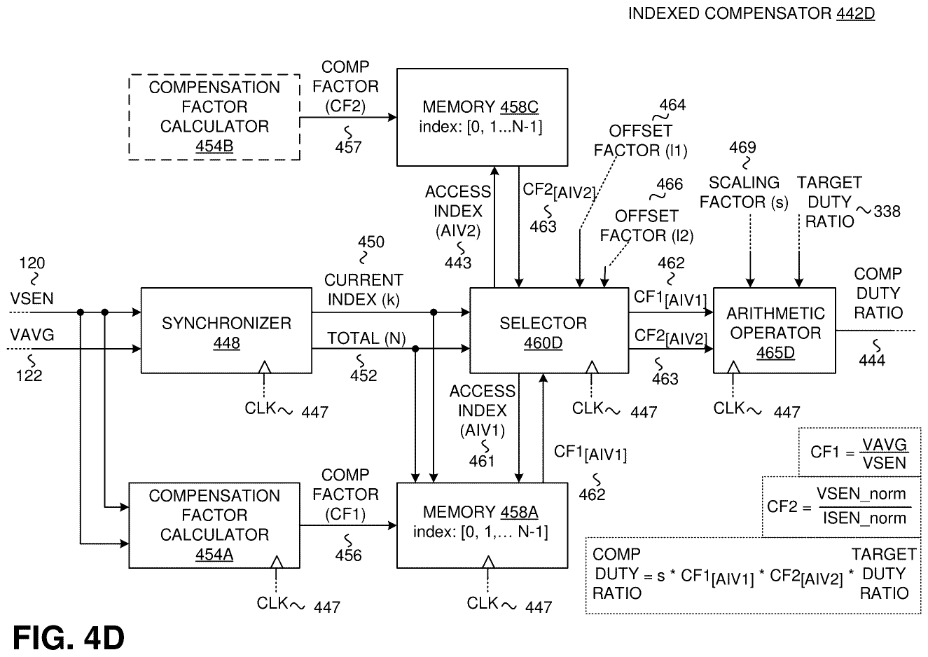

FIG. 4A illustrates an indexed compensator 442A, which is one example of indexed compensator 342 shown in FIG. 3, and it should be appreciated that similarly named and numbered elements couple and function as described above. The indexed compensator 442A is shown as including a synchronizer 448, a compensation factor calculator 454A, a memory 458A, a selector 460A, and an arithmetic operator 465A. As shown, the synchronizer 448, compensation factor calculator 454A, memory 458A, selector 460A, and arithmetic operator 465A are coupled to receive a clock signal CLK 447. The frequency of the clock signal CLK 447 is substantially the frequency of the control loop of the system controller 314. The timing of the actions of the synchronizer 448, compensation factor calculator 454A, memory 458A, selector 460A, and arithmetic operator 465A are in response to the clock signal CLK 447. The indexed compensator 442A compensates for input voltage V_{IN} 106 ripple.

The synchronizer 448 is coupled to receive the sensed input voltage signal VSEN 120. The synchronizer 448 is also coupled to receive the average input voltage signal VAVG 122. In one example, the average input voltage signal VAVG 122 is sensed from input voltage V_{IN} 106. In another example, the average input voltage signal is calculated from the sensed input voltage signal VSEN 120. The synchronizer 448 outputs the current index value (k) 450. The synchronizer 448 also outputs the total (N) 452 number of segments within a period T_{IN} 123 of the sensed input voltage signal VSEN 120. The synchronizer 448 determines the total number of cycles of the clock signal CLK 447 which occur in one period T_{IN} 123 of the sensed input voltage signal VSEN 120. The cycles may also be referred to as clock signal cycles. The total count of clock signal CLK 447 cycles is output as the total (N) 452 number of segments. In one example, the period T_{IN} 123 is measured from peak to peak of the sensed input voltage signal VSEN 120. As such, the total (N) 452 is the total count of clock signal CLK 447 cycles from peak to peak of the sensed input voltage signal VSEN 120. The current index value (k) 450 is the current count of the clock signal CLK 447 cycles by the synchronizer 448.

Compensation factor calculator 454A is coupled to receive the sensed input voltage signal VSEN 120 and the average input voltage signal VAVG 122. The compensation factor calculator 454A outputs the compensation factor (CF) 456 in response to the sensed input voltage signal VSEN 120 and the average input voltage signal VAVG 122. In operation, the compensation factor calculator 454A determines the compensation factor (CF) 456 for each segment of the sensed input voltage signal VSEN 120. The compensation factor calculator 454A determines the compensation factor (CF) 456 at every cycle of the clock signal CLK 447. Compensation factor calculator 454A then outputs the compensation factor (CF) 456 to the memory 458A

The compensation factor calculator 454A shown in FIG. 4A determines the compensation factor (CF) 456 for the ripple present in the input voltage V_{IN} 106. As mentioned above, the compensation factor is the ratio of the target value of the element which the system controller 314 is compensating for and the actual value of the element. The target value for input voltage compensation is the average input voltage signal VAVG 122. As such, the compensation factor calculator 454A outputs compensation factor (CF) 456 which is substantially the ratio of the average input voltage signal VAVG 122 to the sensed input voltage signal VSEN 120,

$$CF = \frac{VAVG}{VSEN}$$

and shown in equation (1) above.

Memory 458A is coupled to receive the compensation factor (CF) 456, current index value (k) 450, and the total (N) 452 number of segments. The memory 458A stores the compensation factor (CF) 456 at the location corresponding with the received current index value (k) 450. The location of memory 458A may also be referred to as a reference, pointer, or address. A circular register may be utilized for the memory 458A. The compensation factors stored in the memory 458A may be accessed utilizing the index values. As will be further discussed, the memory 458A may receive a request to output the compensation factor stored at an access index value (AIV) 461. In response to the request, the memory 458A outputs the stored compensation factor 462 at the access index value (AIV) 461. The index values may be used as references for the memory 458A. For example, the memory 458A stores the compensation factor (CF) 456 at the index value substantially equal to the current index value (k) 450. In another example, the memory 458A retrieves the stored compensation factor 462 from the index value substantially equal to the access index value (AIV) 461.

Selector 460A is coupled to receive the current index value (k) 450 and the total (N) 452 number of segments. Selector 460A is also coupled to receive an offset factor (l) 464. The selector 460A determines an access index value (AIV) 461. The access index value is representative of the wanted storage location of the compensation factor in memory 458A. The selector 460A outputs the access index value (AIV) 461 to memory 458A. The stored compensation factor 462 is retrieved from the memory 458A at the location indicated by the access index value (AIV) 461. Selector 460A receives the stored compensation factor 462 at the access index value (AIV) 461.

The selector 460A determines the access index value (AIV) 461 in response to the current index value (k) 450 and the offset factor (1) 464. The access index value (AIV) 461 is substantially equal to the sum of the current index value (k) 450 and the offset factor (l) 464, or mathematically: AIV=k+l, as discussed previously with respect to equation (3).

If, however, sum of the current index value (k) 450 and the offset factor (l) 464 is greater than or equal to the total (N) 452 number of segments, the access index value (AIV) 461 is substantially the sum of the current index value (k) 450 and the offset factor (l) 464 minus the total (N) 452 number of segments, or mathematically:

$$Access Index Value ( AIV ) = ( k + l ) - N \qquad ( 4 )$$

The offset factor is representative of how far ahead (e.g. leading) or how far behind (e.g. trailing) the current index value will the indexed compensator 442A compensate the target duty ratio 338 of the motor drive system 100. A positive offset factor is representative of leading compensation while a negative offset factor is representative of trailing compensation. In an embodiment, the indexed compensator 442A utilizes leading compensation to apply the stored compensation factor 462 to the target duty ratio 338. Leading compensation may be utilized to consider the delay from selecting the stored compensation factor 462 to controlling the turn ON and turn OFF of the switches of the respective half-bridge modules. Leading compensation may also be utilized to account for the delay of the control signals CTRLU 126a, CTRLV 126b, CTRLW 126c and the actual state of the motor drive system 100. For example, the motor 112 is an inductive load and the phase of the current trails behind an applied voltage. As such, to compensate for an instantaneous value, leading compensation should be utilized.

In one example, the frequency of the sensed input voltage signal VSEN 120 is substantially 120 Hertz (Hz) while the frequency of the control loop for the system controller 314 is substantially 8 kHz. For that example, there is approximately sixty-six total (N) 452 number of segments in a period T_{IN} of the sensed input voltage signal VSEN 120. If the current index value (k) 450 is substantially 15 and the offset factor (l) is substantially 2, the access index value is substantially 17. If the current index value (k) 450 is substantially 65 and the offset factor (l) is substantially 2, the access index value (AIV) 461 is substantially 1.

The arithmetic operator 465A receives the stored compensation factor 462 at the access index value (AIV) 461 and the target duty ratio 338. In the example shown, the arithmetic operator 465A receives the stored compensation factor 462 from the selector 460A. In another example, the arithmetic operator 465A receives the stored compensation factor 462 from memory 458A. The arithmetic operator 465A outputs the compensated duty ratio 444. In one example operation, the arithmetic operator 465A performs multiplication. However, the arithmetic operator 465A may perform other operations, such as division, subtraction, or addition. Further, the arithmetic operator 465A may perform multiple operations. The arithmetic operator 465A outputs the compensated duty ratio 444 which is substantially the product of the stored compensation factor 462 and the target duty ratio 338, or mathematically:

$$Compensated Duty Ratio = {CF}_{[ A / V ]} * Target Duty Ratio .$$

FIG. 4B illustrates an indexed compensator 442B, which is one example of indexed compensator 342 shown in FIG. 3, and it should be appreciated that similarly named and numbered elements couple and function as described above. The indexed compensator 442B is shown as including synchronizer 448, a compensation factor calculator 454B, memory 458A, selector 460A, and an arithmetic operator 465B. As shown, the synchronizer 448, compensation factor calculator 454B, memory 458A, selector 460A, and arithmetic operator 465B are coupled to receive a clock signal CLK 447. The frequency of the clock signal CLK 447 is substantially the frequency of the control loop of the system controller 314. The timing of the various actions of synchronizer 448, compensation factor calculator 454A, memory 458B, selector 460A, and arithmetic operator 465B are in response to the clock signal CLK 447. The indexed compensator 442B compensates for the shape of the input current I_{IN} 108.

Indexed compensator 442B shares many similarities with indexed compensator 442A shown in FIG. 4A and similarly named and numbered elements couple and function as described above. At least one difference, however, is the indexed compensator 442B compensates for the input current I_{IN} 108. As such, the compensation factor calculator 454B calculates a different compensation factor than the compensation factor calculator 454A shown in FIG. 4A.

Compensation factor calculator 454B is coupled to receive the sensed input voltage signal VSEN 120 and the sensed input current signal ISEN 124. The compensation factor calculator 454B outputs the compensation factor (CF) 456 in response to the sensed input voltage signal VSEN 120 and the sensed input current signal ISEN 124. In operation, the compensation factor calculator 454B determines the compensation factor (CF) 456 for each segment of the sensed input voltage signal VSEN 120. The compensation factor calculator 454B determines the compensation factor (CF) 456 at every cycle of the clock signal CLK 447. Compensation factor calculator 454B then outputs the compensation factor (CF) 456 to the memory 458A

The compensation factor calculator 454B shown in FIG. 4B determines the compensation factor (CF) 456 for the shape of the input current I_{IN}. As mentioned above, the compensation factor is the ratio of the target value of the element which the system controller 314 is compensating for and the actual value of the element. The target value for input current compensation is the sensed input voltage signal VSEN 120. However, the sensed input voltage signal VSEN 120 and the sensed input current signal ISEN 124 may not be in the same scale and should be normalized to each other. As such, compensation factor (CF) 456 is the ratio of the normalized sensed input voltage signal VSEN 120 to the normalized sensed input current signal ISEN 124, or mathematically:

$$CF = \frac{VSEN\_norm}{ISEN\_norm} ,$$

Another difference compared to FIG. 4A is the arithmetic operator 465B. arithmetic operator 465B is coupled to receive a scaling factor 469. The scaling factor 469 is represented by the variable s. The arithmetic operator 465B also receives the stored compensation factor 462 at the access index value (AIV) 461 and the target duty ratio 338. In the example shown, arithmetic operator 465B receives the stored compensation factor 462 from the selector 460A. In another example, the arithmetic operator 465B receives the stored compensation factor 462 from memory 458A. The arithmetic operator 465B outputs the compensated duty ratio 444. In one example operation, the arithmetic operator 465B performs multiplication. However, the arithmetic operator 465B may perform other operations, such as division, subtraction, or addition. Further, the arithmetic operator 465B may perform more than one operation. The arithmetic operator 465B outputs the compensated duty ratio 444 which is substantially the product of the stored compensation factor 462, the target duty ratio 338, and the scaling factor 469, or mathematically: Compensated Duty Ratio=s*CF_{[AIV]}*Target Duty Ratio. The scaling factor 469 is representative of how strongly the compensation factor affects the target duty ratio. If the scaling factor 469 is less than one, the effect of the compensation factor is attenuated. If the scaling factor 469 is greater than one, the effect of the compensation factor is amplified.

FIG. 4C illustrates an indexed compensator 442C, which is one example of indexed compensator 342 shown in FIG. 3, and it should be appreciated that similarly named and numbered elements couple and function as described above. The indexed compensator 442C is shown as including synchronizer 448, a memory 458C, selector 460A, and arithmetic operator 465B. As shown, the synchronizer 448, selector 460A, and arithmetic operator 465B are coupled to receive a clock signal CLK 447. The frequency of the clock signal CLK 447 is substantially the frequency of the control loop of the system controller 314. The timing of the various actions of the synchronizer 448, selector 460A, and arithmetic operator 465B are in response to the clock signal CLK 447. The indexed compensator 442C compensates for the shape if the input current I_{IN} 108. The indexed compensator 442C illustrates an embodiment in which the compensation factors (CF) 456 are pre-calculated and subsequently stored in memory 458C.

Indexed compensator 442C shares many similarities with indexed compensator 442A of FIG. 4A and indexed compensator 442B of FIG. 4B and similarly named and numbered elements couple and function as described above. At least one difference, however, is the compensation factor calculation is not performed by the indexed compensator 442C. The compensation factor calculator 454B is shown in dashed lines to indicate that the indexed compensation 442C does not include the compensation factor calculator 454B. The compensation factor calculator 454B determines the compensation factor (CF) 456, which is substantially the ratio of the normalized sensed input voltage signal VSEN 120 to the normalized sensed input current signal ISEN 124, or mathematically:

$$CF = \frac{VSEN\_norm}{ISEN\_norm} ,$$

as shown by equation (2). However, the compensation factor calculator 454B does not continually calculate the compensation factor (CF) 456. Rather, the compensation factor calculator 454B pre-calculates the compensation factor (CF) 456 for each segment 129 of the period T_{IN} 123. It should also be appreciated that a reference sinusoidal waveform IREFSINE may be utilized to determine the compensation factor CF. As mentioned above, the compensation factor may be the ratio between the reference sinusoidal waveform IREFSINE and the sensed input current ISEN 124.

Another difference is the memory 458C. Memory 458C is coupled to receive and store the compensation factor (CF) 456. However, the stored compensation factors in the memory 458C are not updated after the initial storing. As such, the memory 458C does not receive the current index value (k) 450 or the total (N) 452 number of segments as shown in FIGS. 4A and 4B. The compensation factors stored in the memory 458C may be accessed utilizing the index values. The memory 458C may receive a request to output the compensation factor stored at an access index value (AIV) 461. In response to the request, the memory 458C outputs the stored compensation factor 462 at the access index value (AIV) 461. In other words, the memory 458C retrieves the stored compensation factor 462 from the index value substantially equal to the access index value (AIV) 461.

FIG. 4D illustrates an indexed compensator 442D, which is one example of indexed compensator 342 shown in FIG. 3, and it should be appreciated that similarly named and numbered elements couple and function as described above. The indexed compensator 442D is shown as including synchronizer 448, compensation factor calculator 454A, memory 458A, memory 458C, selector 460D, and an arithmetic operator 465D. As shown, the synchronizer 448, compensation factor calculator 454A, memory 458A, selector 460D, and arithmetic operator 465D are coupled to receive a clock signal CLK 447. The frequency of the clock signal CLK 447 is substantially the frequency of the control loop of the system controller 314. The timing of the various actions of synchronizer 448, compensation factor calculator 454A, memory 458A, selector 460D, and arithmetic operator 465D are in response to the clock signal CLK 447. The indexed compensator 442D compensates for both the input voltage V_{IN} 106 and the input current I_{IN} 108.

Indexed compensator 442D shares many similarities with indexed compensator 442A of FIG. 4A, indexed compensator 442B of FIG. 4B, and the indexed compensator 442C of FIG. 4C and similarly named and numbered elements couple and function as described above. At least one difference, however, is the indexed compensator 442D compensates for both the input voltage V_{IN} 106 and the input current I_{IN} 108.

For input voltage V_{IN} 106 compensation, the indexed compensator 442D utilizes compensation factor calculator 454A and memory 458A shown and described with respect to FIG. 4A. Compensation factor calculator 454A is coupled to receive the sensed input voltage signal VSEN 120 and the average input voltage signal VAVG 122 and outputs the compensation factor CF1 456. In operation, the compensation factor calculator 454A determines the compensation factor CF1 456 for each segment of the sensed input voltage signal VSEN 120. The compensation factor calculator 454A determines the compensation factor CF1 456 at every cycle of the clock signal CLK 447. The compensation factor calculator 454A outputs compensation factor CF1 456 which is substantially the ratio of the average input voltage signal VAVG 122 to the sensed input voltage signal VSEN 120,

$$CF = \frac{VAVG}{VSEN}$$

and shown in equation (1) above.

Memory 458A is coupled to receive the compensation factor (CF) 456, current index value (k) 450, and the total (N) 452 number of segments. The memory 458A stores the compensation factor CF1 456 at the location corresponding with the received current index value (k) 450. The location of memory 458A may also be referred to as a reference, pointer, or address. The compensation factors stored in the memory 458A may be accessed utilizing the index values. The memory 458A receives a request to output the compensation factor stored at an access index value (AIV1) 461. In response to the request, the memory 458A outputs the stored compensation factor CF1 462 at the access index value (AIV1) 461. The memory 458A stores the compensation factor (CF1) 456 at the index value substantially equal to the current index value (k) 450. In another example, the memory 458A retrieves the stored compensation factor 462 from the index value substantially equal to the access index value (AIV1) 461.

For input current I_{IN} 108 compensation, the indexed compensator 442D utilizes the memory 458C shown and described with respect to FIG. 4C is utilized. As such, the compensation factors CF2 457 are pre-calculated and then stored in memory 458C. The compensation factor calculator 454B is shown in dashed lines to indicate the compensation factor calculation is not performed by the indexed compensator 442D. The compensation factor calculator 454B determines the compensation factor (CF2) 457, which is substantially the ratio of the normalized sensed input voltage signal VSEN 120 to the normalized sensed input current signal ISEN 124, or mathematically:

$$CF = \frac{VSEN\_norm}{ISEN\_norm} ,$$

as shown by equation (2). The compensation factor (CF2) 457 may be referred to as an additional compensation factor.

Memory 458C is coupled to receive and store the compensation factor CF2 457. However, the stored compensation factors in the memory 458C are not updated after the initial storing. Similar to FIG. 4C, the memory 458C does not receive the current index value (k) 450 or the total (N) 452 number of segments as shown in FIGS. 4A and 4B. The compensation factors stored in the memory 458C may be accessed utilizing the index values. The memory 458C may receive a request to output the compensation factor stored at an access index value (AIV2) 443. The memory 458C retrieves the stored compensation factor 463 from the index value substantially equal to the access index value (AIV2) 443. In response to the request, the memory 458C outputs the stored compensation factor CF2 463 at the access index value. The memory 458C may be referred to as an additional memory and the corresponding access index value (AIV2) 443 for memory 458C as an additional access index value.

Another difference is selector 460D. As shown, selector 460D is coupled to receive multiple offset factors. Selector 460D is also coupled to output the stored compensation factor CF1 462 retrieved from the memory 458A and the stored compensation factor CF2 463 retrieved from memory 458C. Selector 460D is coupled to receive the current index value (k) 450 and the total (N) 452 number of segments. Selector 460D is also coupled to receive an offset factor (l1) 464 and offset factor (l2) 466.

The selector 460D determines access index values (AIV1) 461 and (AIV2) 443 for memory 458A and memory 458C. The access index values are representative of the wanted storage locations of the compensation factors in memory 458A and memory 458D. The selector 460D determines the access index values (AIV1) 461 and (AIV2) 443. Selector 460D outputs the access index value (AIV1) 461 to memory 458A and access index value (AIV2) 443 to memory 458C. It should be appreciated that the offset factors l1 464 and l2 466 may be the same or different and as such the access index values (AIV1) 461 and (AIV2) 443 may also be the same or different. The stored compensation factors CF1 462 and CF2 463 are retrieved from their respective memories 458A and 458C at the locations indicated by their respective access index values AIV1 461 and AIV2 443. Selector 460D receives the stored compensation factor CF1 462 and CF2 463 at their respective access index values AIV1 461 and AIV2 443.

The access index value (AIV1) 461 for memory 458A is in response to the current index value (k) 450 and the offset factor (l1) 464. The access index value (AIV1) 461 is substantially equal to the sum of the current index value (k) 450 and the offset factor (l1) 464, or mathematically: AIV1=k+l1. If, however, sum of the current index value (k) 450 and the offset factor (l1) 464 is greater than or equal to the total (N) 452 number of segments, the access index value (AIV1) 461 is substantially the sum of the current index value (k) 450 and the offset factor (l1) 464 minus the total (N) 452 number of segments, or mathematically: AIV1=(k+l1)−N.

Similarly, the access index value (AIV2) 443 for memory 458C is in response to the current index value (k) 450 and the offset factor (l2) 466. The access index value (AIV2) 443 is substantially equal to the sum of the current index value (k) 450 and the offset factor (l2) 466, or mathematically: AIV2=k+12. If, however, sum of the current index value (k) 450 and the offset factor (l2) 466 is greater than or equal to the total (N) 452 number of segments, the access index value (AIV2) 443 is substantially the sum of the current index value (k) 450 and the offset factor (l2) 466 minus the total (N) 452 number of segments, or mathematically: AIV2=(k+l2)−N. The offset factor (l2) 466 may be referred to as an additional offset factor.

Arithmetic operator 465D receives the stored compensation factor CF1 462, the stored compensation factor CF2 463, the target duty ratio 338, and a scaling factor(s) 469. The arithmetic operator 465D outputs the compensated duty ratio 444. In one example operation, the arithmetic operator 465D performs multiplication. However, the arithmetic operator 465D may perform other operations, such as division, subtraction, or addition. Further, the arithmetic operator 465D may perform multiple operations. The arithmetic operator 465D outputs the compensated duty ratio 444 which is substantially the product of the stored compensation factor CF1 462, the stored compensation factor CF2 463, the target duty ratio 338, and a scaling factor(s) 469 or mathematically: Compensated Duty Ratio=s*CF1_{[AIV1]}*CF2_{[AIV2]}*Target Duty Ratio. The stored compensation factor CF2 463 may be referred to as the additional stored compensation factor.

It should be appreciated that while the indexed compensator 442D is shown as generating two compensation factors and includes two memories. The indexed compensator may compensate for any number of elements and may generate any number of compensation factors which are stored in any number of memories.

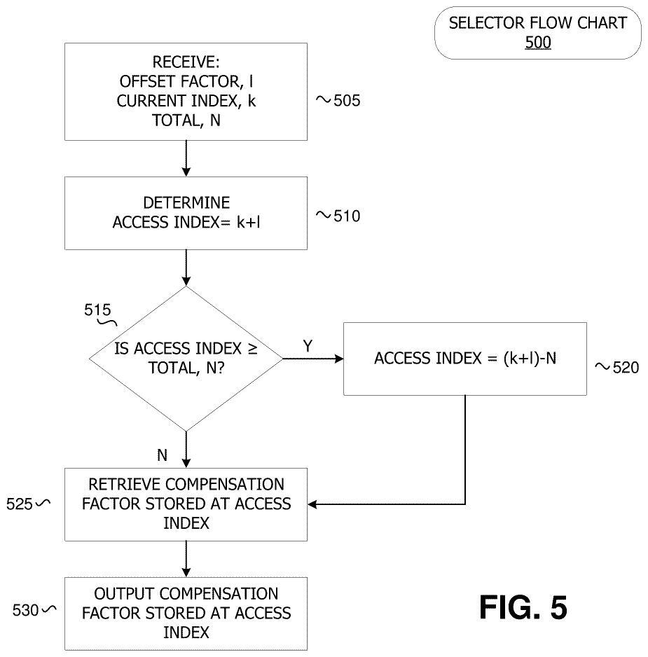

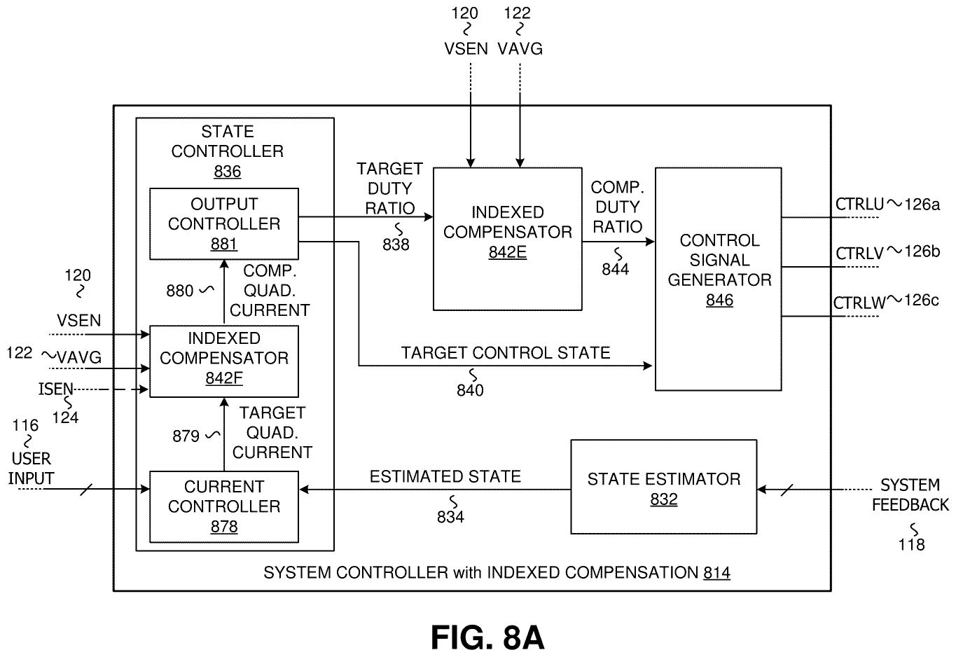

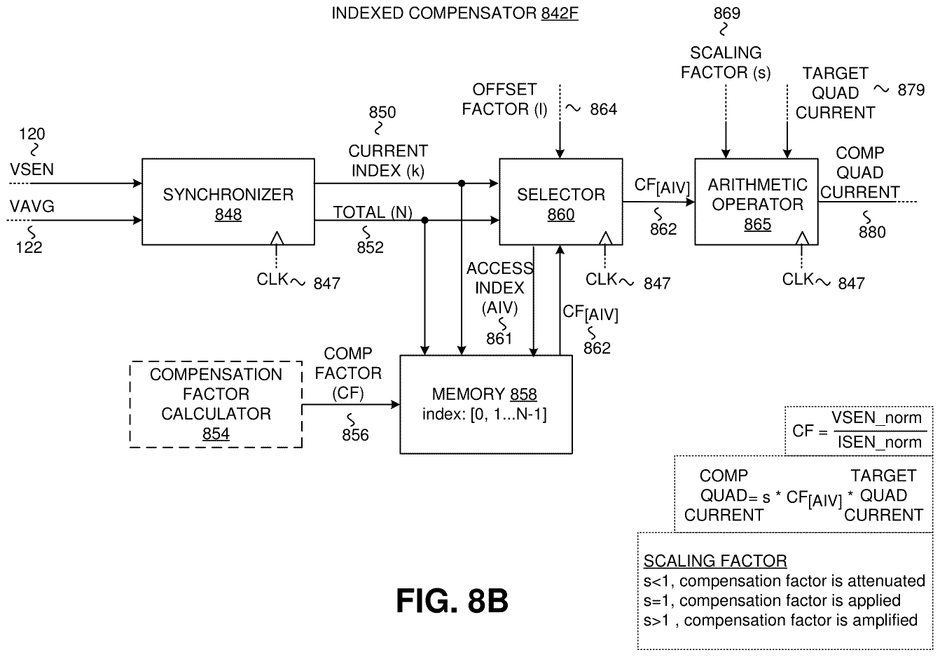

FIG. 5 is a flow chart 500 illustrating one method of selecting a compensation factor CF. It should be appreciated that the flow chart 500 may be applicable to selector 460A shown in FIGS. 4A, 4B, and 4C and selector 460D shown in FIG. 4D, and selector 860 of FIG. 8B.

At block 505, the offset factor (l), current index (k), and the total (N) number of segments are received. At block 510, the access index value (AIV) is initially determined as the sum of the offset factor (l) and current index (k), or mathematically: AIV=k+l.

At decision block 515, it is determined if the access index value (AIV) determined in block 510 is greater than or equal to the total (N) number of segments, or mathematically: AIV≥N. In other words, at decision block 515 it is determined if the sum of the offset factor (l) and current index (k) is greater than or equal to the total (N) number of segments, or mathematically: k+l≥N.

If the sum of the offset factor (l) and current index (k) is greater than or equal to the total (N) number of segments, the process proceeds to block 520. In block 520, the access index value (AIV) is determined as the sum of offset factor (l) and current index (k) minus the total (N) number of segments, or mathematically: AIV=(k+l)−N.

The process proceeds to block 525 after block 520. The process proceeds to block 525 after decision block 515 if the sum of the offset factor (l) and current index (k) is less than the total (N) number of segments. At block 525, the compensation factor stored at the access index value of the memory is retrieved. It should be appreciated that if the process proceeds to block 525 from decision block 515, the access index value is substantially the sum of the offset factor (l) and current index (k). If the process proceeds to block 525 from block 520, the access index value is substantially the sum of offset factor (l) and current index (k) minus the total (N) number of segments. At block 530 the retrieved compensation factor stored at the access index value is outputted. In one example, the various actions of blocks 505, 510, 515, 520, 525, and 530 are performed in one clock cycle of the clock signal 447. In another example, the various actions of blocks 505, 510, 515, 520, 525, and 530 may be performed over multiple clock cycles.

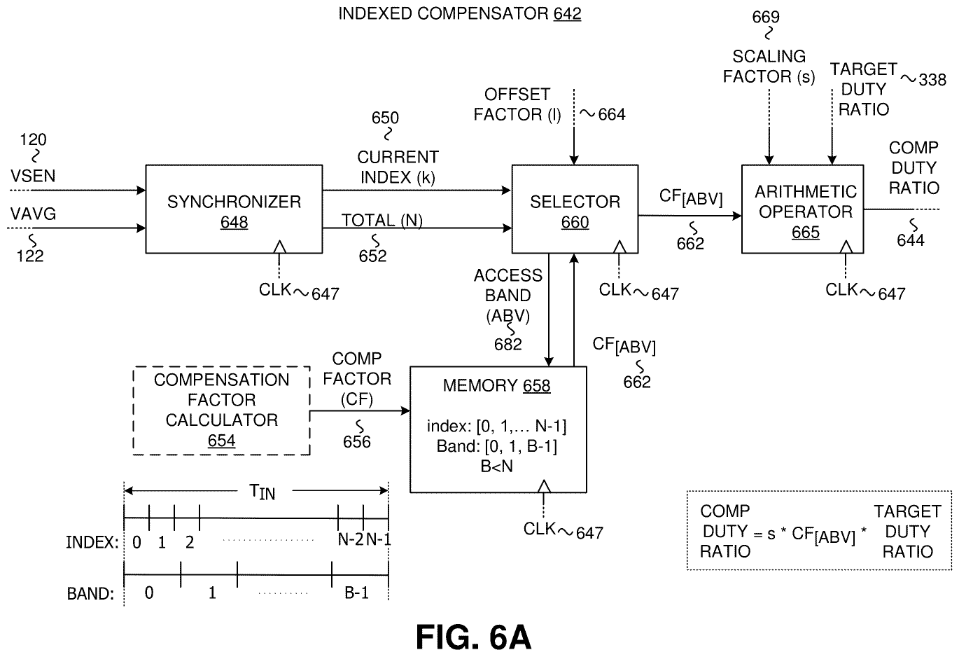

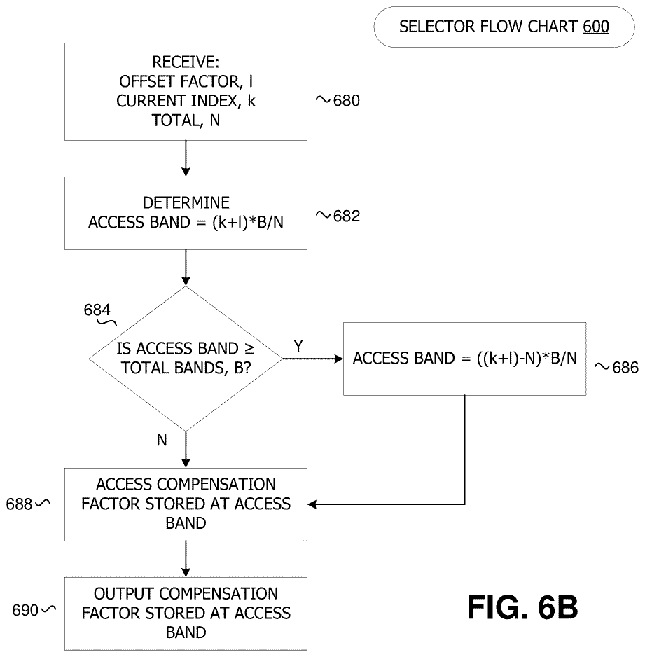

FIG. 6A illustrates an indexed compensator 642, which is one example of indexed compensator 342 shown in FIG. 3, and it should be appreciated that similarly named and numbered elements couple and function as described above. The indexed compensator 642A is shown as including a synchronizer 648, a memory 658, a selector 660, and an arithmetic operator 665. As shown, the synchronizer 648, selector 660, and arithmetic operator 665 are coupled to receive a clock signal CLK 647. The frequency of the clock signal CLK 647 is substantially the frequency of the control loop of the system controller 314. The timing of the various actions of the synchronizer 648, selector 660, and arithmetic operator 665 are in response to the clock signal CLK 647. For the example shown, the indexed compensator 642 compensates for the shape of the input current I_{IN} 108. Further, the compensation factors are pre-calculated and stored in memory 658.

The indexed compensator 642 shares many similarities with the indexed compensators 442A, 442B, 442C, and 442D shown in FIGS. 4A, 4B, 4C and 4D. At least one difference, however, is the segments and corresponding index value may be part of bands. There is a total of B number of bands, and the total B number of bands is less than the total N number of segments for the period T_{IN} 123 of the sensed input voltage signal VSEN 120. The bands may be referenced by a band value.

Synchronizer 648 shares many similarities with synchronizer 448. The synchronizer 648 is coupled to receive the sensed input voltage signal VSEN 120 and the average input voltage signal VAVG 122. The synchronizer 648 outputs the current index value (k) 650. The synchronizer 648 also outputs the total (N) 652 number of segments within a period T_{IN} 123 of the sensed input voltage signal VSEN 120. The synchronizer 648 determines the total number of cycles of the clock signal CLK 647 which occur in one period T_{IN} 123 of the sensed input voltage signal VSEN 120. The total count of clock signal CLK 647 cycles is output as the total (N) 652 number of segments. In one example, the period T_{IN} 123 is measured from peak to peak of the sensed input voltage signal VSEN 120. As such, the total (N) 652 is the total count of clock signal CLK 647 cycles from peak to peak of the sensed input voltage signal VSEN 120. The current index value (k) 650 is the current count of the clock signal CLK 647 cycles by the synchronizer 648.

Compensation factor calculator 654 shares many similarities with compensation factor calculator 454B shown with respect to FIGS. 4B, 4C, and 4D. The dashed lines indicate that the compensation factor calculation is not performed by the indexed compensator 642. The compensation factor calculator 654 determines the compensation factor (CF) 656, which is substantially the ratio of the normalized sensed input voltage signal VSEN 120 to the normalized sensed input current signal ISEN 124, or mathematically:

$$CF = \frac{VSEN\_norm}{ISEN\_norm} ,$$

as shown by equation (2). However, the compensation factor calculator 654 does not continually calculate the compensation factor (CF) 656. In addition, rather than pre-calculating compensation factors for every segment of the period T_{IN} 123, the compensation factors (CF) 656 is pre-calculated for each band (B) of the period T_{IN} 123.

Memory 658 shares many similarities with memory 458C shown in FIGS. 4C and 4D. Memory 658 is coupled to receive and store the compensation factor (CF) 656. However, the stored compensation factors in the memory 658 are not updated after the initial storing. The compensation factors stored in the memory 658 may be accessed by utilizing the band values. The memory 658 may receive a request to output the compensation factor stored at an access band value (ABV) 682. The memory 658 retrieves the stored compensation factor 462 from the band value substantially equal to the access band value (ABV) 682. In response to the request, the memory 658 outputs the stored compensation factor 662 at the access band value.

Selector 660 shares many similarities with selector 460A. Selector 660 is coupled to receive the current index value (k) 650 and the total (N) 652 number of segments. Selector 660 is also coupled to receive an offset factor (l) 664. The selector 660 determines an access band value (ABV) 682. The access band value (ABV) 682 is representative of the wanted storage location of the compensation factor in memory 658. The selector 660 determines the access band value (ABV) 682. Selector 660 outputs the access band value (ABV) 682 to memory 658. The stored compensation factor 662 is retrieved from the memory 658 at the location indicated by the access band value (ABV) 682. Selector 660 receives the stored compensation factor 662 at the access band value (ABV) 682.

The selector 660 determines the access band value (ABV) 682 in response to the current index value (k) 650, the offset factor (l) 664, the total (N) 652 number of segments and the total (B) number of bands. The access band value (ABV) 682 is substantially equal to the sum of the current index value (k) 650 and the offset factor (l) 664 multiplied by the quotient of the total (B) number of bands and the total (N) 652 number of segments, or mathematically:

$$Access Band Value ( ABV ) = ( k + l ) * \frac{B}{N} \qquad ( 5 )$$

If, however, the sum of the current index value (k) 650 and the offset factor (l) 664 multiplied by the quotient of the total (B) number of bands and the total (N) 652 number of segments is greater than or equal to the total (B) number of bands, the access band value (ABV) 682 is substantially the sum of the current index value (k) 650 and the offset factor (l) 664 minus the total (N) 652 number of segments multiplied by the quotient of the total (B) number of bands and the total (N) 652 number of segments, or mathematically:

$$Access Band Value ( ABV ) = ( ( k + l ) - N ) * \frac{B}{N} \qquad ( 6 )$$

The offset factor is representative of how far ahead (e.g. leading) or how far behind (e.g. trailing) of the current index value will the indexed compensator 642 compensate the target duty ratio 338 of the motor drive system 100. A positive offset factor is representative of leading compensation while a negative offset factor is representative of trailing compensation. In an embodiment, the indexed compensator 642 utilizes leading compensation to apply the stored compensation factor 662 to the target duty ratio 338.

The arithmetic operator 665 shares many similarities with arithmetic operator 465B. Arithmetic operator 665 receives the stored compensation factor 662 at the access band value and the target duty ratio 338. The arithmetic operator 665 is shown as receiving the stored compensation factor 662 from selector 660. However, the arithmetic operator 665 may also receive the stored compensation factor 662 from the memory 658. The arithmetic operator also receives a scaling factor 669, represented by variable s. The arithmetic operator 665 outputs the compensated duty ratio 644. In one example operation, the arithmetic operator 665 performs multiplication. However, the arithmetic operator 665 may perform other operations, such as division, subtraction, or addition. Further, the arithmetic operator 665 may perform multiple operations. The arithmetic operator 665 outputs the compensated duty ratio 644 which is substantially the product of the stored compensation factor 662, the target duty ratio 338, and the scaling factor 669 or mathematically: Compensated Duty Ratio=s*CF_{[ABV]}*Target Duty Ratio. The scaling factor 669 is representative of how strongly the compensation factor affects the target duty ratio. If the scaling factor 669 is less than one, the effect of the compensation factor is attenuated. If the scaling factor 669 is greater than one, the effect of the compensation factor is amplified.

FIG. 6B is a flow chart 600 illustrating one method of selecting a compensation factor for the indexed compensator of FIG. 6A. At block 680, the offset factor (l), current index (k), and the total (N) number of segments are received. At block 682, the access band value (ABV) is initially determined as the sum of the offset factor (l) and current index (k) multiplied by the quotient of the total (B) number of bands and the total (N) number of segments, or mathematically:

$$ABV = ( k + l ) \frac{B}{N} .$$

At decision block 684, it is determined if the access band value (ABV) determined in block 682 is greater than or equal to the total (B) number of bands, or mathematically: ABV≥B. In other words, at decision block 684 it is determined if the sum of the offset factor (l) and current index (k) multiplied by the quotient of the total (B) number of bands and the total (N) number of segments is greater than or equal to the total (B) number of bands, or mathematically:

$$( k + l ) \frac{B}{N} \geq B .$$

If the sum of the offset factor (l) and current index (k) multiplied by the quotient of the total (B) number of bands and the total (N) number of segments is greater than or equal to the total (B) number of bands, the process proceeds to block 686. In block 686, the access band value (ABV) is determined as the sum of the offset factor (l) and current index (k) minus the total (N) number of segments multiplied by the quotient of the total (B) number of bands and the total (N) number of segments, or mathematical:

$$A BV = ( ( k + 1 ) - N ) \frac{B}{N} .$$

The process proceeds to block 688 after block 686. The process proceeds to block 688 after decision block 684 if the sum of the offset factor (l) and current index (k) multiplied by quotient of the total (B) number of bands and the total (N) number of segments is less than the total (B) number of bands. At block 688, the compensation factor stored at the access band value of the memory is retrieved. It should be appreciated that if the process proceeds to block 688 from decision block 684, the access index value is substantially the sum of the offset factor (l) and current index (k) multiplied by the quotient of the total (B) number of bands and the total (N) number of segments. If the process proceeds to block 688 from block 686, the access band value is substantially the sum of the offset factor (l) and current index (k) minus the total (N) number of segments multiplied by the quotient of the total (B) number of bands and the total (N) number of segments. At block 690 the retrieved compensation factor stored at the access band value is outputted. In one example, the various actions of blocks 680, 682, 684, 686, 688, and 690 are performed in one clock cycle of the clock signal 647. In another example, the various actions of 680, 682, 684, 686, 688, and 690 may be performed over multiple clock cycles.

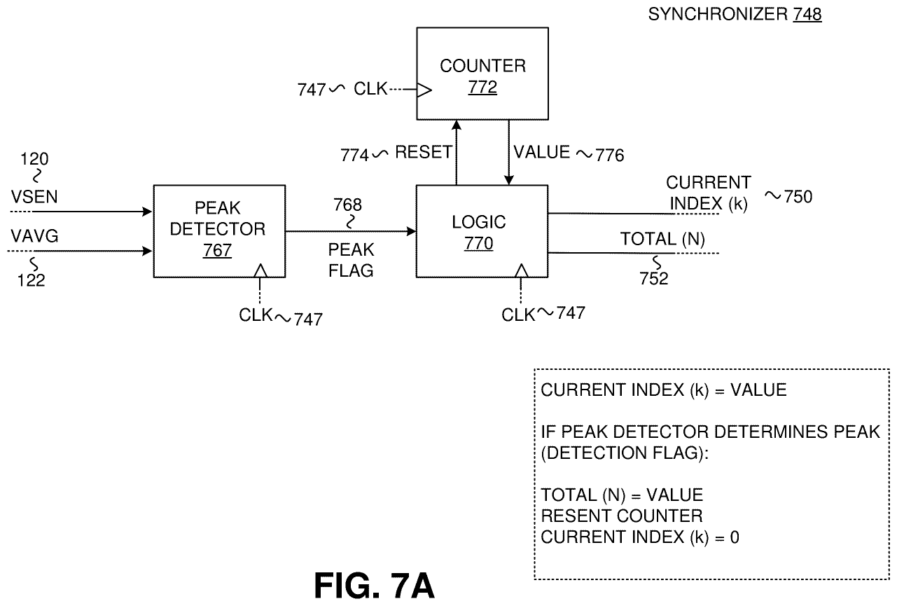

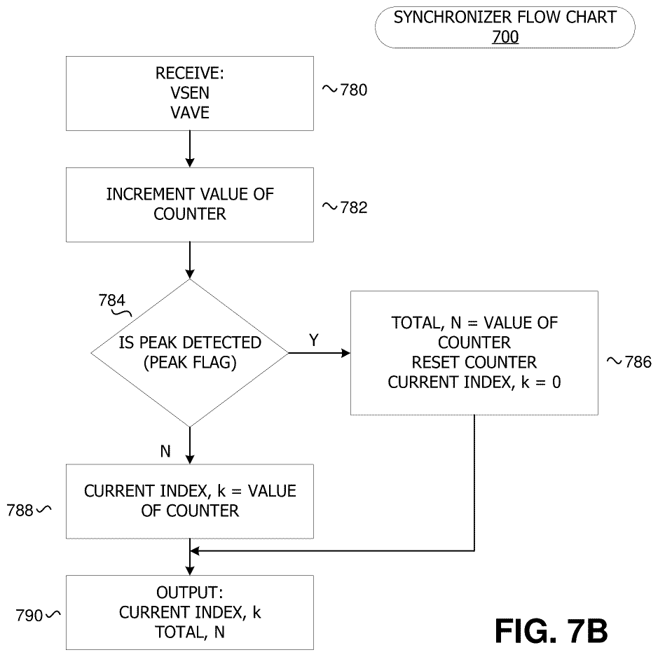

FIG. 7A illustrates synchronizer 748 which is one example of synchronizer 448 of FIGS. 4A, 4B, 4C, and 4D, synchronizer 648 of FIG. 6A, and synchronizer 848 of FIG. 8B. It should be appreciated that similarly named and numbered elements couple and function as discussed. Synchronizer 748 includes peak detector 767, logic block 770, and counter 772. As shown, the peak detector 767, logic block 770, and counter 772 are coupled to receive a clock signal CLK 747. The frequency of the clock signal CLK 747 is substantially the frequency of the control loop of the system controller 314. The timing of the various actions of the peak detector 767, logic block 770, and the counter 772 are in response to the clock signal CLK 747.

The synchronizer 748 is coupled to determine the total (N) 752 number of segments which occur in the period T_{IN} 123 of the sensed input voltage signal VSEN 120. Further, the synchronizer 748 determines the current index value (k) 750 within the period T_{IN} 123. For the example shown, the period T_{IN} 123 is from peak to peak of the input voltage VSEN 120. In operation, the synchronizer 748 synchronizes the current index value (k) and the total (N) 752) number of segments with the period T_{IN} 123 of the sensed input voltage signal VSEN 120. For the example shown, the synchronizer 748 synchronizes with the peaks of the sensed input voltage signal VSEN 120. However, it should be appreciated that the synchronizer 748 may also synchronize with other periodic features of the sensed input voltage signal VSEN 120. For example, the synchronizer 748 may synchronize with a valley of the sensed input voltage signal VSEN 120. In other words, synchronizer 748 synchronizes with the period T_{IN} 123 of the sensed input voltage signal VSEN 120.

Peak detector 767 is coupled to receive the sensed input voltage signal VSEN 120. As shown, peak detector 767 is also coupled to receive the average input voltage signal VAVG 122. In one example, the average input voltage signal VAVG 122 is sensed from input voltage V_{IN} 106. In another example, the average input voltage signal is calculated from the sensed input voltage signal VSEN 120. The peak detector 767 outputs a peak flag signal 768 representative of the detected peak of the sensed input voltage signal VSEN 120. In one example, the peak flag signal 768 is asserted when a peak in the sensed input voltage signal VSEN 120 is detected. As mentioned above, the sensed input voltage signal VSEN 120 is a periodic signal. The peak to peak of the sensed input voltage signal VSEN 120 is substantially the period T_{IN} 123. In operation, the peak detector 767 finds the peak of the sensed input voltage signal VSEN 120 by comparing the sensed input voltage signal VSEN 120 to the average input voltage signal VAVG 122. The peak detector 767 determines if the sensed input voltage signal VSEN 120 is greater or less than the average input voltage signal VAVG 122. The peak detector 767 also determines the difference between the sensed input voltage signal VSEN 120 and the average input voltage signal VAVG 122. In one example, a peak in the sensed input voltage signal VSEN 120 is determined when the sensed input voltage signal VSEN 120 is greater than the average input voltage signal VAVG 122 and when the difference between the sensed input voltage signal VSEN 120 and the average input voltage signal VAVG 122 is the largest. In another example, a peak in the sensed input voltage signal VSEN 120 is determined when the maximum difference between the sensed input voltage signal VSEN 120 and the average input voltage signal VAVG 122 has been detected. As mentioned above, the average input voltage signal VAVG 122 may also be sensed or calculated. In a further example, the peak of the sensed input voltage signal VSEN 120 may be determined by comparing a current value of the sensed input voltage signal VSEN 120 with a previous value of the sensed input voltage signal VSEN 120.

Logic block 770 is coupled to receive the peak flag signal 768. The logic block 770 also receives a value 776 from counter 772 and outputs a reset signal 774 to the counter 772. Counter 772 is shown as receiving the clock signal CLK 747. In operation, the counter increments its internal count in response to the clock signal CLK 747. In particular, the counter 772 increments the internal count with every cycle of clock signal CLK 747. The internal count of the counter 772 is output as the value 776. The internal count of counter 772 is reset to zero in response to the reset signal 774.

Logic block 770 is coupled to output the current index value (k) 750. The synchronizer 748 also outputs the total (N) 752 number of segments within a period T_{IN} 123 of the sensed input voltage signal VSEN 120. In operation, the current index value (k) 750 is substantially the value 776. If the peak flag signal 768 indicates that a peak has been found by the peak detector 767, the total (N) 752 number of segments is substantially the value 776. The logic block 770 then outputs the reset signal 774 to reset the counter 772. Further, logic block 770 outputs the current index value (k) to be substantially zero. The synchronizer 748 determines the total number of cycles of the clock signal CLK 747 which occur in one period T_{IN} 123 of the sensed input voltage signal VSEN 120. The total count of clock signal CLK 747 cycles is output as the total (N) 752 number of segments. The current index value (k) 750 is the current internal count of the clock signal CLK 447 cycles by the counter 772.

FIG. 7B is a flow chart 700 illustrating one method of synchronizing for the synchronizer 748 shown in FIG. 7A. It should be appreciated that the method shown in flow chart 300 may also be utilized by synchronizer 478 shown in FIGS. 4A, 4B, 4C, and 4D, synchronizer 648 of FIG. 6A, and synchronizer 848 of FIG. 8B.

At block 780, the sensed input voltage signal VSEN 120 and the average input voltage signal VAVG 122 is received. At block 782, the internal count of counter 772 is incremented. As such, the value 776 output by counter 772 is also incremented.

At decision block 784, it is determined if the peak of the sensed input voltage signal VSEN 120 has been detected. If the peak of the sensed input voltage signal VSEN 120 has not been detected, the process proceeds to block 788. At block 788 the current index value (k) 750 is the value 776 of counter 772. If the peak of the sensed input voltage signal VSEN 120 has been detected, the process proceeds to block 786. At block 786, the total (N) 752 number of segments is substantially the value 776 of counter 772. The counter 772 is also reset, and the current index value (k) 750 is substantially zero. Blocks 786 and 788 proceed to block 790, and the current index value (k) 750 and total (N) 752 number of segments are outputted. In one example, the various actions of blocks 780, 782, 784, 786, 788, and 790 are performed in one clock cycle of the clock signal 747. In another example, the various actions of 780, 782, 784, 786, 788, and 790 may be performed over multiple clock cycles.

FIG. 8A illustrates a system controller 814 which includes an indexed compensator 842E and indexed compensator 842F. The system controller 814 is one example of system controller 114, and similarly named and numbered elements couple and function as described above. The system controller 814 includes a state estimator 832, a state controller 836, an indexed compensator 842E, and a control signal generator 846. The state controller 836 is shown as including current controller 878, indexed compensator 842E, and output controller 881. The system controller 814 shares many similarities with the system controller 314 of FIG. 3, and it should be appreciated that similarly named and numbered elements couple and function as discussed above. At least one difference, however, is the system controller 814 includes an indexed compensator 842F within the state controller 836. Further, the system controller 814 utilizes field-oriented control.

State estimator 832 is coupled to receive system feedback 118. The system feedback 118 is representative of one or more parameters of the motor drive system 100. For example, system feedback 118 may include current sense signals representative of the phase currents I_{PHASEU} 128a, I_{PHASEV} 128b, and I_{PHASEW} 128c of the motor 112. The system feedback 118 may also include a position signal representative of the position of the rotor of motor 112. The state estimator 832 determines and outputs the estimated state 834 of the motor drive system 100 in response to the system feedback 118. The estimated state 834 is representative of the current state of the motor 112 for whichever control scheme the motor drive system 100 is utilizing. For the example of field-oriented control, the estimated state 834 may be the determined rotor angle and phase current vector representative as a direct-component and a quadrature-component.

State controller 836 is coupled to receive the user input 116 and the estimated state 834. State controller 836 is also coupled to receive the sensed input voltage signal VSEN 120. State controller 836 is also shown as receiving the average input voltage signal VAVG 122. State controller 836 may optionally receive the sensed input current signal ISEN 124, as shown by the dashed lines. As shown, the current controller 878 is coupled to receive the user input 116 and the estimated state 834. Current controller 878 receives one or more command signals from a user input 116 to control the operation of the motor 112. For example, system controller 114 may receive an “ON” command to turn on and begin operation of motor 112, or conversely, may receive an “OFF” command to stop operation of motor 106. Further command signals from user input 116 may include the desired mechanical outputs of the motor 112, such as the speed or torque. In response to the one or more commands from the user input 116 and the determined current estimated state 834 of the motor 112, the current controller 878 outputs the target quadrature current 879.

The indexed compensator 842F is coupled to receive the target quadrature current 879 and the sensed input voltage signal VSEN 120. Indexed compensator 842F is also coupled to receive the average input voltage signal VAVG 122. It should be appreciated that the average input voltage signal VAVG 122 may be sensed or calculated. The indexed compensator 842F may also receive the sensed input current ISEN 124, as shown by the dashed lines. The indexed compensator 842F outputs a compensated quadrature current 880. The indexed compensator 842F compensates the quadrature current with compensation factors which are indexed to the input voltage V_{IN} 106. In response to the sensed input voltage signal VSEN 120, the indexed compensator 842F determines the current index value and an access index value. The indexed compensator 842F selects the compensation factor stored at the access index value and outputs the compensated quadrature current 880. Indexed compensator 842F may also be referred to as an additional indexed compensator.

The output controller 881 receives the compensated quadrature current 880 and outputs a target duty ratio 838 and a target control state 840. The output controller 881 determines the desired control state to operate the motor 112. The target duty ratio 838 is representative of the desired percentage used of the input voltage V_{IN} 106 used by the motor drive system 100. The target control state 840 is representative of the desired control state of the motor 112 for whichever control scheme utilized by the system controller 814. For the example of field-oriented control, the estimated state may be the desired stator angle representative as the control signals for the direct-component and quadrature-component.

Indexed compensator 842E is coupled to receive the sensed input voltage signal VSEN 120, the average input voltage signal VAVG 122, and the target duty ratio 838. The indexed compensator 842E receives the target duty ratio 838 and outputs a compensated duty ratio 844. Indexed compensator 842E compensates for the input voltage V_{IN} 106 ripple. In response to the sensed input voltage signal VSEN 120, the indexed compensator 842F determines the current index value and an access index value. The indexed compensator 842E selects the compensation factor stored at the access index value and outputs the compensated duty ratio 844. The indexed compensator 842E may be one example of indexed compensator 442A.

Control signal generator 846 is coupled to receive the target control state 840 and the compensated duty ratio 844. Control signal generator 846 outputs control signal CTRLU 126a, CTRLV 126b, and CTRLW 126c in response to the target control state 840 and the compensated duty ratio 844. In operation, the control signal generator 846 converts the compensated duty ratio 844 and the target control state 840 to the control signals CTRLU 126a, CTRLV 126b, and CTRLW 126c used to control the respective half-bridge modules. The conversion by the control signal generator 846 is determined by the control scheme implemented by the system controller 314. In the example of field-oriented control, the control signal generator 846 includes the reference frame translator and space vector modulator.

FIG. 8B illustrates indexed compensator 842F including a synchronizer 848, a memory 858, a selector 860, and an arithmetic operator 865. As shown, the synchronizer 848, selector 860, and arithmetic operator 865 are coupled to receive a clock signal CLK 847. The frequency of the clock signal CLK 847 is substantially the frequency of the control loop of the system controller 814. The timing of the various actions of the synchronizer 848, selector 860, and arithmetic operator 865 are in response to the clock signal CLK 847. For the example shown, the indexed compensator 842F compensates for the shape of the input current I_{IN} 108. Further, the compensation factors are pre-calculated and stored in memory 858.

It should be appreciated that indexed compensator 842F shares many similarities with the indexed compensator 442C of FIG. 4C, and similarly named and numbered elements couple and function as described above. At least one difference, however, is indexed compensator 842F compensates the target quadrature current, rather than the target duty ratio shown in FIG. 4C. Indexed compensator 842F illustrates compensation factors which are pre-calculated and stored in memory 858. It should be appreciated that the calculation of compensation factors and storage into the memory, as shown by indexed compensator 442B of FIG. 4B, may also be utilized by indexed compensator 842F.

Synchronizer 848 shares many similarities with synchronizer 448 and 648. The synchronizer 848 is coupled to receive the sensed input voltage signal VSEN 120 and the average input voltage signal VAVG 122. The synchronizer 848 outputs the current index value (k) 850. The synchronizer 848 also outputs the total (N) 852 number of segments within a period T_{IN} 123 of the sensed input voltage signal VSEN 120. The synchronizer 848 determines the total number of cycles of the clock signal CLK 847 which occur in one period T_{IN} 123 of the sensed input voltage signal VSEN 120. The total count of clock signal CLK 847 cycles is output as the total (N) 852 number of segments. In one example, the period T_{IN} 123 is measured from peak to peak of the sensed input voltage signal VSEN 120. As such, the total (N) 852 is the total count of clock signal CLK 847 cycles from peak to peak of the sensed input voltage signal VSEN 120. The current index value (k) 850 is the current count of the clock signal CLK 847 cycles by the synchronizer 848.

Compensation factor calculator 854 shares many similarities with compensation factor calculator 454B and 654. The dashed lines indicate that the compensation factor calculation is not performed by the indexed compensator 842. The compensation factor calculator 854 determines the compensation factor (CF) 856, which is substantially the ratio of the normalized sensed input voltage signal VSEN 120 to the normalized sensed input current signal ISEN 124, or mathematically:

$$CF = \frac{VSEN\_norm}{ISEN\_norm} ,$$

as shown by equation (2). However, the compensation factor calculator 854 does not continually calculate the compensation factor (CF) 856. Rather, the compensation factor (CF) 856 for each segment of the period T_{IN} 123 is pre-calculated.

Memory 858 shares many similarities with memory 458C and memory 658. Memory 858 is coupled to receive and store the compensation factor (CF) 856. However, the stored compensation factors in the memory 858 are not updated after the initial storing. The compensation factors stored in the memory 858 may be accessed utilizing the index values. The memory 858 may receive a request to output the compensation factor stored at an access index value (AIV) 861. In response to the request, the memory 858 outputs the stored compensation factor 862 at the access index value. The memory 858 retrieves the stored compensation factor 862 from the index value substantially equal to the access index value (AIV) 861. The access index value (AIV) 861 may also be referred to as an additional access index value.

Selector 860 shares many similarities with selector 460A and selector 660. Selector 860 is coupled to receive the current index value (k) 850 and the total (N) 852 number of segments. Selector 860 is also coupled to receive an offset factor (l) 864. The selector 860 determines an access index value (AIV) 861. The access index value (AIV) 861 is representative of the wanted storage location of the compensation factor in memory 858. The selector 860 determines the access index value (AIV) 861. The stored compensation factor 862 is retrieved from the memory 858 at the location indicated by the access index value (AIV) 861. Selector 860 receives the stored compensation factor 862. The stored compensation factor 862 may also be referred to as additional stored compensation factor.

The selector 860 determines the access index value (AIV) 861 in response to the current index value (k) 850, the offset factor (l) 864, and the total (N) 852 number of segments. The access index value (AIV) 861 is substantially equal to the sum of the current index value (k) 850 and the offset factor (l), or mathematically: AIV=k+l

If, however, the sum of the current index value (k) 850 and the offset factor (l) 864 is greater than or equal to the total (N) 852 number of segments, the access index value (AIV) 861 is substantially the sum of the current index value (k) 850 and the offset factor (l) 864 minus the total (N) 852 number of, or mathematically: AIV=(k+l)−N.

The arithmetic operator 865 shares many similarities with arithmetic operator 465B and 665. At least one difference, however, is arithmetic operator 865 is coupled to receive the target quadrature current 879 rather than the target duty ratio and outputs the compensated quadrature current 880 rather than the compensated duty ratio. Arithmetic operator 865 receives the stored compensation factor 862 and the target quadrature current 879. In the example shown, the arithmetic operator 865 receives the stored compensation factor 862 from selector 860. In another example, the arithmetic operator 865 receives the stored compensation factor 862 from memory 858. The arithmetic operator 865 also receives a scaling factor 869, represented by variable s. The arithmetic operator 865 outputs the compensated quadrature current 880. In one example operation, the arithmetic operator 865 performs multiplication. However, the arithmetic operator 865 may perform other operations, such as division, subtraction, or addition. Further, the arithmetic operator 865 may perform multiple operations. The arithmetic operator 865 outputs the compensated quadrature current 880 which is substantially the product of the stored compensation factor 862, the target quadrature current 879, and the scaling factor(s) 869 or mathematically: Compensated Quad Current=s*CF_{[AIV]}*Target Quad Current.

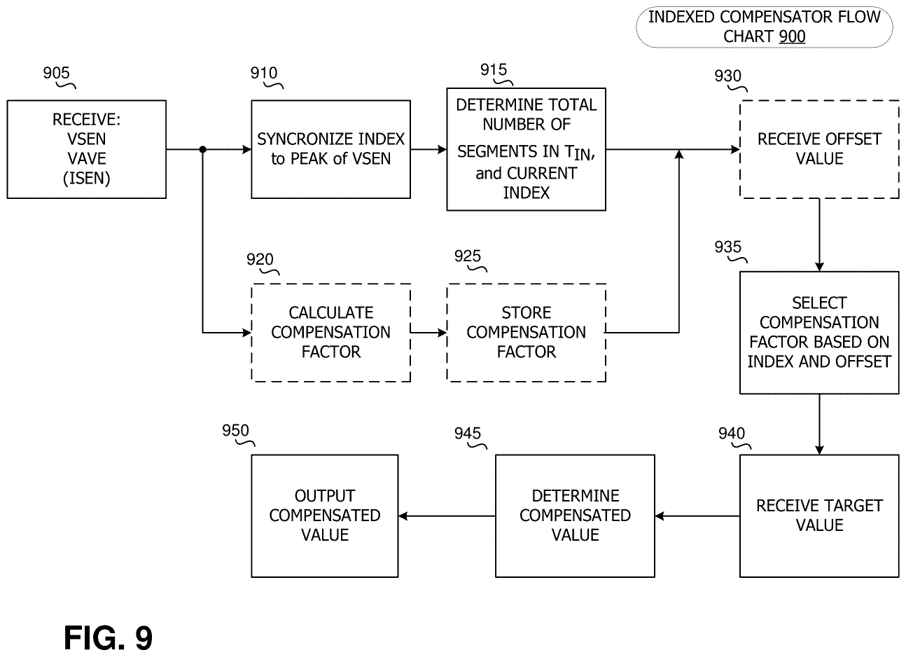

FIG. 9 is a flow chart 900 illustrating one method of indexed compensation. At block 905, the sensed input voltage signal VSEN and average input voltage signal VAVG are received. Optionally, the sensed input current signal ISEN may also be received. The process proceeds to block 910. At block 910, the segments and index values are synchronized with the peak of the sensed input voltage signal VSEN. In one example, the peak of the sensed input voltage signal VSEN corresponds with an index value of zero. Then at block 915, the total N number of segments is determined in the period T_{IN}. The period T_{IN} of the sensed input voltage signal VSEN may be determined from peak to peak of the sensed input voltage signal VSEN. At block 915, the current index value is also determined in response to the sensed input voltage signal VSEN.

After block 905, the process optionally proceeds to block 920 as shown by the dashed box. In block 920, compensation factors are calculated. The compensation factors may be calculated for each segment and corresponding index value of the sensed input voltage signal VSEN. The process proceeds to block 925. At block 925, the compensation factors are stored. If the process includes block 920, the calculated compensation factors are stored. However, if the process does not include block 920, pre-calculated compensation factors are stored.

From block 915 and 925, the process optionally proceeds to block 930 as shown by the dashed box. At block 930, an offset value is received. The process continues to block 935. At block 935, the compensation factor is selected in response to the current index value. If the process includes block 930, the compensation factor is selected in response to the current index value and the offset factor. For example, the compensation factor corresponding to the index value substantially equal to the sum of the current index value and the offset factor may be selected. If the sum of the current index value and the offset factor is greater than or equal to the total (N) number of segments, the compensation factor corresponding to the index value substantially equal to the sum of the current index value and the offset factor minus the total (N) number of segments may be selected.

At block 940, the target value is received. For example, the target value may be a target duty ratio or a target quadrature current. At block 945, the compensated value is determined. In one example, the compensated value may be the product of the target value and the compensation factor. Further, a scaling factor may also be utilized to determine how much the compensation factor affects the target value. As such, the compensated value may be the product of the target value, compensation factor, and the scaling factor. At block 950, the compensated value is outputted. In one example, the various actions of blocks 905, 910, 915, 935, 940, 945, and 950, along with actions of blocks 920, 925, and 930 when utilized, are performed in one clock cycle of the clock signal. In another example, the various actions of 905, 910, 915, 935, 940, 945, and 950, along with actions of blocks 920, 925, and 930 when utilized, may be performed over multiple clock cycles.

Numerous specific details are set forth above in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention. For example, skilled artisans will appreciate that elements in the previously described figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in the figures in order to facilitate a less obstructed view of these various embodiments of the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality.

The description of illustrated examples of the present invention, including what is described in the Abstract, are not intended to be exhaustive or to be a limitation to the precise forms disclosed. While specific embodiments of, and examples for, the invention are described herein for illustrative purposes, various equivalent modifications are possible without departing from the broader spirit and scope of the present invention. Indeed, it is appreciated that any specific example voltages, currents, frequencies, power range values, times, etc., are provided for explanation purposes and that other values may also be employed in other embodiments and examples in accordance with the teachings of the present invention.

Although the present invention is defined in the claims, it should be understood that the present invention can alternatively be defined in accordance with the following examples:

Example 1. A system controller for a motor drive system, comprising: a state controller coupled to receive a command from a user input and to output a target duty ratio for the motor drive system; an indexed compensator coupled to receive the target duty ratio and coupled to perform operations comprising receiving a sensed input voltage signal representative of an input voltage of the motor drive system; determining a total number of segments and a current index value of the sensed input voltage signal; determining an access index value based on the current index value; selecting a stored compensation factor in response to the access index value; and outputting a compensated duty ratio in response to a product of the stored compensation factor and the target duty ratio; and a control signal generator coupled to generate control signals for a plurality of devices that operate to drive the motor drive system in response to the compensated duty ratio.

Example 2. The system controller of example 1, wherein the indexed compensator is coupled to synchronize the total number of segments and the current index value with a period of the sensed input voltage signal.

Example 3. The system controller of example 1 or 2, wherein the indexed compensator is coupled to synchronize the total number of segments and the current index value from a first peak to a second peak of the sensed input voltage signal.

Example 4. The system controller of any one of examples 1 to 3, wherein the indexed compensator is coupled to perform operations in response to a clock signal with clock signal cycles, wherein the total number of segments is a number of clock signal signals in the period of the sensed input voltage signal.

Example 5. The system controller of any one of examples 1 to 4, wherein the indexed compensator further comprises: a memory coupled to store a compensation factor for each segment of the sensed input voltage signal, wherein the compensation factor is retrieved with reference to an index value.

Example 6. The system controller of any one of examples 1 to 5, wherein the indexed compensator further comprises: a compensation factor calculator coupled to receive the sensed input voltage signal and an average input voltage signal representative of an average of the input voltage of the motor drive system, wherein the compensation factor calculator is coupled to calculate the compensation factor as substantially a ratio of an average input voltage signal to the sensed input voltage signal.

Example 7. The system controller of any one of examples 1 to 6, wherein the indexed compensator further comprises: a compensation factor calculator coupled to receive the sensed input voltage signal and a sensed input current signal representative of an input current of the motor drive system, wherein the compensation factor calculator is further coupled to calculate the compensation factor as substantially a ratio of a normalized sensed input voltage signal to a normalized sensed input current signal.

Example 8. The system controller of any one of examples 1 to 7, the indexed compensator further comprising a selector coupled to receive the current index value, the total number of segments, and an offset factor, wherein the selector is coupled to determine the access index value, the access index value is substantially a sum of the current index value and the offset factor when the sum of the current index value and the offset factor is less than the total number of segments, the access index value is substantially the sum of the current index value and the offset factor minus the total number of segments when the sum of the current index value and the offset factor is greater than or equal to the total number of segments, and the memory is coupled to output the stored compensation factor referenced at the access index value.

Example 9. The system controller of any one of examples 1 to 8, wherein the indexed compensator further comprises an arithmetic operator coupled to receive the stored compensation factor and the target duty ratio and to output the compensated duty ratio in response to the product of the stored compensation factor and the target duty ratio.

Example 10. The system controller of any one of examples 1 to 9, wherein the arithmetic operator is further coupled to receive a scaling factor, wherein the compensated duty ratio is output in response to a product of the stored compensation factor, the target duty ratio, and the scaling factor.

Example 11. The system controller of any one of examples 1 to 10, wherein the index compensator further comprises: an additional memory coupled to store an additional compensation factor for each segment of the sensed input voltage signal, wherein the additional compensation factor is retrieved with reference to the index value; wherein the selector is further coupled to receive an additional offset factor to determine an additional access index value, the additional access index value is substantially a sum of the current index value and the additional offset factor when the sum of the current index value and the additional offset factor is less than the total number of segments, the additional access index value is substantially the sum of the current index value and the additional offset factor minus the total number of segments when the sum of the current index value and the additional offset factor is greater than or equal to the total number of segments, and the additional memory is coupled to output an additional stored compensation factor referenced at the additional access index value; and an arithmetic operator coupled to receive the additional stored compensation factor and to output the compensated duty ratio in response to a product of the stored compensation factor, the additional stored compensation factor, the target duty ratio, and the scaling factor.

Example 12. The system controller of any one of examples 1 to 11, wherein the state controller further comprises: a current controller coupled to receive the command from the user input and to output a target quadrature current of the motor drive system; an additional indexed compensator coupled to receive the target quadrature current and coupled to perform operations comprising: receiving the sensed input voltage signal; determining the total number of segments and the current index value of the sensed input voltage signal; determining an additional access index value based on the current index value; selecting an additional stored compensation factor in response to the access index value; and outputting a compensated quadrature current in response to a product of the additional stored compensation factor and the target quadrature current; and an output controller coupled to receive the compensated quadrature current and to output the target duty ratio of the motor drive system in response to the compensated quadrature current.

Example 13. A system controller for a motor drive system, comprising: a state controller coupled to receive a command from a user input and to output a target duty ratio for the motor drive system; an indexed compensator coupled to receive the target duty ratio and comprising: a synchronizer coupled to receive a sensed input voltage signal representative of an input voltage of the motor drive system, wherein the synchronizer determines a current index value and a total number of segments of the sensed input voltage signal; a selector coupled to receive the current index value, the total number of segments, a total number of bands, and an offset factor, wherein the selector is coupled to determine an access band value based on the current index value; a memory coupled to output a compensation factor in response to the access band value; and an arithmetic operator coupled to output a compensated duty ratio in response to a product of the compensation factor, the target duty ratio, and a scaling factor; and a control signal generator coupled to generate control signals for a plurality of devices that operate to drive the motor drive system in response to the compensated duty ratio.

Example 14. The system controller of example 13, wherein the access band value is substantially a sum of the current index value and the offset factor multiplied by a quotient of the total number of bands to the total number of segments when the sum of the current index value and the offset factor multiplied by the quotient of the total number of bands to the total number of segments is less than the total number of bands, and the access band value is substantially the sum of the current index value and the offset factor minus the total number of segments multiplied by the quotient of a total number of bands to the total number of segments when the sum of the current index value and the offset factor is greater than or equal than the total number of bands.

Example 15. A method for compensating a target duty ratio of a motor drive system, the method comprising: receiving a sensed input voltage signal representative of an input voltage of the motor drive system and the target duty ratio; determining a total number of segments and a current index value of sensed input voltage signal; determining an access index value based on the current index value; selecting a stored compensation factor in response to the access index value; and outputting a compensated duty ratio in response to a product of the stored compensation factor and the target duty ratio.

Example 16. The method of example 15, wherein determining the total number of segments and the current index value further comprises synchronizing the total number of segments and the current index value with a period of the sensed input voltage signal.

Example 17. The method of example 15 or 16, wherein synchronizing the total number of segments and the current index value with the period of the sensed input voltage signal further comprises synchronizing the total number of segments and the current index value with the peak of the sensed input voltage signal.

Example 18. The method of any one of examples 15 to 17, wherein determining the access index value further comprises: receiving an offset factor; determining if a sum of the current index value and the offset factor is greater than or equal to the total number of segments; and determining the access index value, wherein the access index value is substantially the sum of the current index value and the offset factor if the sum of the current index value and the offset factor is less than the total number of segments, wherein the access index value is substantially the sum of the current index value and the offset factor minus the total number of segments if the sum of the current index value and the offset factor is greater than the total number of segments.

Example 19. The method of any one of examples 15 to 18, wherein outputting the compensated duty ratio further comprises: receiving a scaling factor; and outputting the compensated duty ratio in response to a product of the stored compensation factor, the target duty ratio, and the scaling factor.

Example 20. The method of any one of examples 15 to 19, further comprising: receiving an average input voltage signal representative of an average of the input voltage of the motor drive system; calculating a compensation factor, wherein the compensation factor is substantially a ratio of the average input voltage signal to the sensed input voltage signal; and storing the compensation factor.

Example 21. The method of any one of examples 15 to 20, further comprising: receiving a sensed input current signal representative of an input current of the motor drive system; calculating a compensation factor, wherein the compensation factor is substantially a ratio of a normalized sensed input voltage signal to a normalized sensed input current signal; and storing the compensation factor.

What is claimed is:

1. A system controller for a motor drive system, comprising:
a state controller coupled to receive a command from a user input and to output a target duty ratio for the motor drive system;
an indexed compensator coupled to receive the target duty ratio and configured to perform operations comprising:
receiving a sensed input voltage signal representative of an input voltage of the motor drive system;
determining a total number of segments and a current index value of the sensed input voltage signal;
determining an access index value based on the current index value;
selecting a stored compensation factor in response to the access index value; and
outputting a compensated duty ratio in response to a product of the stored compensation factor and the target duty ratio; and
a control signal generator configured to generate control signals for a plurality of devices that operate to drive the motor drive system in response to the compensated duty ratio.

2. The system controller of claim 1, wherein the indexed compensator is further configured to perform operations comprising synchronizing the total number of segments and the current index value with a period of the sensed input voltage signal.

3. The system controller of claim 2, wherein the indexed compensator is further configured to perform operations comprising synchronizing the total number of segments and the current index value with a first peak to a second peak of the sensed input voltage signal.

4. The system controller of claim 2, wherein the indexed compensator is configured to perform operations in response to a clock signal with clock signal cycles, wherein the total number of segments is a number of clock signal signals in the period of the sensed input voltage signal.

5. The system controller of claim 1, wherein the indexed compensator further comprises:
a memory configured to store a compensation factor for each segment of the sensed input voltage signal, wherein the compensation factor is retrieved with reference to an index value.

6. The system controller of claim 5, wherein the indexed compensator further comprises:
a compensation factor calculator coupled to receive the sensed input voltage signal and an average input voltage signal representative of an average of the input voltage of the motor drive system, wherein the compensation factor calculator is configured to calculate the compensation factor as substantially a ratio of an average input voltage signal to the sensed input voltage signal.

7. The system controller of claim 5, wherein the indexed compensator further comprises:
a compensation factor calculator coupled to receive the sensed input voltage signal and a sensed input current signal representative of an input current of the motor drive system, wherein the compensation factor calculator is further configured to calculate the compensation factor as substantially a ratio of a normalized sensed input voltage signal to a normalized sensed input current signal.

8. The system controller of claim 5, the indexed compensator further comprising a selector coupled to receive the current index value, the total number of segments, and an offset factor, wherein
the selector is configured to determine the access index value,
the access index value is substantially a sum of the current index value and the offset factor when the sum of the current index value and the offset factor is less than the total number of segments,
the access index value is substantially the sum of the current index value and the offset factor minus the total number of segments when the sum of the current index value and the offset factor is greater than or equal to the total number of segments, and
the memory is configured to output the stored compensation factor referenced at the access index value.

9. The system controller of claim 8, wherein the indexed compensator further comprises an arithmetic operator coupled to receive the stored compensation factor and the target duty ratio and configured to output the compensated duty ratio in response to the product of the stored compensation factor and the target duty ratio.

10. The system controller of claim 9, wherein the arithmetic operator is further coupled to receive a scaling factor, wherein the compensated duty ratio is output in response to a product of the stored compensation factor, the target duty ratio, and the scaling factor.

11. The system controller of claim 10, wherein the index compensator further comprises:
an additional memory coupled to store an additional compensation factor for each segment of the sensed input voltage signal, wherein the additional compensation factor is retrieved with reference to the index value;
wherein the selector is further coupled to receive an additional offset factor to determine an additional access index value,
the additional access index value is substantially a sum of the current index value and the additional offset factor when the sum of the current index value and the additional offset factor is less than the total number of segments,
the additional access index value is substantially the sum of the current index value and the additional offset factor minus the total number of segments when the sum of the current index value and the additional offset factor is greater than or equal to the total number of segments, and
the additional memory is configured to output an additional stored compensation factor referenced at the additional access index value; and
an arithmetic operator coupled to receive the additional stored compensation factor and configured to output the compensated duty ratio in response to a product of the stored compensation factor, the additional stored compensation factor, the target duty ratio, and the scaling factor.

12. The system controller of claim 1, wherein the state controller further comprises:
a current controller coupled to receive the command from the user input and configured to output a target quadrature current of the motor drive system;
an additional indexed compensator coupled to receive the target quadrature current and configured to perform operations comprising:
receiving the sensed input voltage signal;
determining the total number of segments and the current index value of the sensed input voltage signal;
determining an additional access index value based on the current index value;
selecting an additional stored compensation factor in response to the access index value; and
outputting a compensated quadrature current in response to a product of the additional stored compensation factor and the target quadrature current; and
an output controller coupled to receive the compensated quadrature current and configured to output the target duty ratio of the motor drive system in response to the compensated quadrature current.

13. A system controller for a motor drive system, comprising:
a state controller coupled to receive a command from a user input and configured to output a target duty ratio for the motor drive system;
an indexed compensator coupled to receive the target duty ratio and comprising:
a synchronizer coupled to receive a sensed input voltage signal representative of an input voltage of the motor drive system, wherein the synchronizer is configured to determine a current index value and a total number of segments of the sensed input voltage signal;
a selector coupled to receive the current index value, the total number of segments, a total number of bands, and an offset factor, wherein the selector is configured to determine an access band value based on the current index value;
a memory configured to output a compensation factor in response to the access band value; and
an arithmetic operator configured to output a compensated duty ratio in response to a product of the compensation factor, the target duty ratio, and a scaling factor; and
a control signal generator configured to generate control signals for a plurality of devices that operate to drive the motor drive system in response to the compensated duty ratio.

14. The system controller of claim 13, wherein the access band value is substantially a sum of the current index value and the offset factor multiplied by a quotient of the total number of bands to the total number of segments when the sum of the current index value and the offset factor multiplied by the quotient of the total number of bands to the total number of segments is less than the total number of bands, and
the access band value is substantially the sum of the current index value and the offset factor minus the total number of segments multiplied by the quotient of a total number of bands to the total number of segments when the sum of the current index value and the offset factor is greater than or equal than the total number of bands.

15. A method for compensating a target duty ratio of a motor drive system, the method comprising:
receiving a sensed input voltage signal representative of an input voltage of the motor drive system and the target duty ratio;
determining a total number of segments and a current index value of the sensed input voltage signal;
determining an access index value based on the current index value;
selecting a stored compensation factor in response to the access index value; and
outputting a compensated duty ratio in response to a product of the stored compensation factor and the target duty ratio.

16. The method of claim 15, wherein determining the total number of segments and the current index value further comprises synchronizing the total number of segments and the current index value with a period of the sensed input voltage signal.

17. The method of claim 16, wherein synchronizing the total number of segments and the current index value with the period of the sensed input voltage signal further comprises synchronizing the total number of segments and the current index value with a peak of the sensed input voltage signal.

18. The method of claim 15, wherein determining the access index value further comprises:
receiving an offset factor;
determining if a sum of the current index value and the offset factor is greater than or equal to the total number of segments; and
determining the access index value,
wherein the access index value is substantially the sum of the current index value and the offset factor if the sum of the current index value and the offset factor is less than the total number of segments,
wherein the access index value is substantially the sum of the current index value and the offset factor minus the total number of segments if the sum of the current index value and the offset factor is greater than the total number of segments.

19. The method of claim 15, wherein outputting the compensated duty ratio further comprises:
receiving a scaling factor; and
outputting the compensated duty ratio in response to a product of the stored compensation factor, the target duty ratio, and the scaling factor.

20. The method of claim 15, further comprising:
receiving an average input voltage signal representative of an average of the input voltage of the motor drive system;
calculating a compensation factor, wherein the compensation factor is substantially a ratio of the average input voltage signal to the sensed input voltage signal; and
storing the compensation factor.

21. The method of claim 15, further comprising:
receiving a sensed input current signal representative of an input current of the motor drive system;
calculating a compensation factor, wherein the compensation factor is substantially a ratio of a normalized sensed input voltage signal to a normalized sensed input current signal; and
storing the compensation factor.
